(19) United States
(12) Patent Application Publication
(10) Pub. No.: US 2024/0333117 A1
(43) Pub. Date: Oct. 3, 2024

(54) VIBRATION DEVICE

(71) Applicants: Yuki TAKAHASHI, Tokyo (JP); Tomoya ISHITANI, Tokyo (JP); Shinji HIRABAYASHI, Tokyo (JP)

(72) Inventors: Yuki TAKAHASHI, Tokyo (JP); Tomoya ISHITANI, Tokyo (JP); Shinji HIRABAYASHI, Tokyo (JP)

(73) Assignee: MINEBEA MITSUM Inc., Nagano (JP)

(21) Appl. No.: 18/574,099

(22) PCT Filed: Jun. 29, 2022
(86) PCT No.: PCT/JP2022/026066

§ 371 Date: Dec. 26, 2023

(30) Foreign Application Priority Data
Jun. 30, 2021 (JP) 2021-109238

(51) Int. Cl. H02K 33/18

(52) U.S. Cl. CPC H02K 33/18

(57) ABSTRACT

This vibration device comprises: a vibration actuator which drives and vibrates a movable body supported in an elastically vibratable manner with respect to a fixed body, in one direction of the vibration directions of the movable body; and an accommodation part which seals and accommodates therein the vibration actuator, wherein the vibration actuator is attached to an inner wall of the accommodation part with a support member therebetween, the support member extending in one direction. The support member supports, with respect to the inner wall, one among the movable body and the fixed body of the vibration actuator.

### TECHNICAL FIELD

The present invention relates to a vibration device that vibrates a vibration object.

### BACKGROUND ART

A vibration device is known in which when an operator operates an operation device such as a touch panel, vibration corresponding to the operation is applied as a sense of contact operation to the operator's finger touching the operation device (see PTL 1).

### CITATION LIST

### Patent Literature

### PTL 1

Japanese Patent Publication No. 6249454

### SUMMARY OF INVENTION

### Technical Problem

There is a demand of using a vibration device in an environment such as outdoors exposed to wind and rain, for example. However, a vibration device such as that disclosed in PTL 1 has a structure of applying vibration to a vibration object by directly bringing a vibrating portion into contact with the vibration object, and as such defects may be caused due to foreign matters such as dusts and moisture such as rain entered the vibration device. As a result, a vibration device as that disclosed in PTL 1 is influenced by the ambient environment.

In addition, vibration devices using magnets are also known, but such devices have high device costs, and are influenced by the ambient environment, i.e., the ambient temperature due to the temperature characteristics of the magnet, which may change the intensity of the vibration and cause problems about the reliability of the vibration operation.

An object of the present invention is to provide a vibration device that can apply vibration to the vibration object regardless of the surrounding environment.

### Solution to Problem

A vibration device according to the present invention includes a vibration actuator configured to vibrate a movable body by driving the movable body in one direction of a vibration direction of the movable body, the movable body being supported such that the movable body is allowed to elastically vibrate with respect to a fixing body; and a housing part configured to house and seal the vibration actuator inside the housing part. The vibration actuator is attached at an inner wall of the housing part via a supporting member extending in the one direction.

### Advantageous Effects of Invention

According to the present invention, vibration can be applied to the vibration object regardless of the surrounding environment.

### BRIEF DESCRIPTION OF DRAWINGS

FIG. 1 is a perspective view of a vibration device according to an embodiment (Embodiment 1) of the present invention as viewed from an obliquely upper side;

FIG. 2 is an exploded perspective view of a main configuration of the vibration device illustrated in FIG. 1, as viewed from an obliquely upper side;

FIG. 3 is an exploded perspective view of a main configuration of the vibration device illustrated in FIG. 1, as viewed from an obliquely lower side;

FIG. 4 is another exploded perspective view of a part of the vibration device illustrated in FIG. 2, as viewed from an obliquely upper side;

FIG. 5 is another exploded perspective view of a part of the vibration device illustrated in FIG. 3, as viewed from an obliquely lower side;

FIG. 6 is an enlarged view of a cable portion connected to an electromagnetic actuator provided in the vibration device illustrated in FIG. 1;

FIG. 7 is a diagram for describing a part of the inside of the vibration device illustrated in FIG. 1;

FIG. 8 is a diagram illustrating a variation (Variation 1) of the vibration device illustrated in FIG. 1;

FIG. 9 is a diagram illustrating a variation (Variation 2) of the vibration device illustrated in FIG. 1;

FIG. 10 is a diagram illustrating a variation (Variation 3) of the vibration device illustrated in FIG. 1;

FIG. 11 is a perspective view of an electromagnetic actuator provided in the vibration device illustrated in FIG. 1, as viewed from an obliquely upper side;

FIG. 12 is a perspective view of the electromagnetic actuator illustrated in FIG. 11, as viewed from an obliquely lower side;

FIG. 13 is a sectional view of the electromagnetic actuator illustrated in FIG. 11 taken along line A-A;

FIG. 14 is an exploded perspective view of the electromagnetic actuator illustrated in FIG. 11;

FIG. 15 is a diagram illustrating a configuration of a magnetic circuit of the electromagnetic actuator illustrated in FIG. 11;

FIGS. 16A and 16B are diagrams for describing an operation of the electromagnetic actuator illustrated in FIG. 11;

FIG. 17 is a diagram illustrating a vibration unit including the vibration device illustrated in FIG. 1;

FIG. 18 is a diagram for describing an example (example configuration 1) of the vibration unit illustrated in FIG. 17;

FIG. 19 is a diagram for describing an example (example configuration 2) of another vibration unit;

FIG. 20 is a diagram for describing an example (example configuration 3) of another vibration unit;

FIG. 21 is a diagram for describing an example (example configuration 4) of another vibration unit;

FIG. 22 is a diagram for describing an example (example configuration 5) of another vibration unit;

FIG. 23 is a perspective view of a vibration device according to an embodiment (Embodiment 2) of the present invention as viewed from an obliquely upper side;

FIG. 24 is an exploded perspective view of a main configuration of the vibration device illustrated in FIG. 23, as viewed from an obliquely upper side;

FIG. 25 is an exploded perspective view of a main configuration of the vibration device illustrated in FIG. 23, as viewed from an obliquely lower side;

FIG. 26 is another exploded perspective view of a part of the vibration device illustrated in FIG. 24, as viewed from an obliquely upper side;

FIG. 27 is another exploded perspective view of a part of the vibration device illustrated in FIG. 25, as viewed from an obliquely lower side;

FIG. 28 is a diagram for describing a part of the inside of the vibration device illustrated in FIG. 23;

FIG. 29 is a diagram illustrating a variation (Variation 1) of the vibration device illustrated in FIG. 23;

FIG. 30 is a diagram illustrating a variation (Variation 2) of the vibration device illustrated in FIG. 23;

FIG. 31 is a diagram illustrating a variation (Variation 3) of the vibration device illustrated in FIG. 23;

FIG. 32 is a diagram illustrating a mounting example of a vibration unit with a vibration object attached to the vibration device illustrated in FIG. 1; and

FIG. 33 is a diagram illustrating an installation example of the vibration unit illustrated in FIG. 32.

### DESCRIPTION OF EMBODIMENTS

An embodiment of the present invention is elaborated below with reference to the accompanying drawings.

The present embodiment is described by using an orthogonal coordinate system (X, Y, Z). The drawings described later are also described with the common orthogonal coordinate system (X, Y, Z). In the following, the width, depth and height of vibration devices 100A and 100B are the lengths in the X direction, Y direction and Z direction, respectively, and the width, depth, height of electromagnetic actuator 10 are the lengths in the X direction, Y direction, and Z direction, respectively. In addition, the plus side in the Z direction is the direction in which the vibration is applied to the vibration object and referred to as “upper side”, and the minus side in the Z direction is the direction away from the vibration object and referred to as “lower side”.

### Vibration Device 100A of Embodiment 1

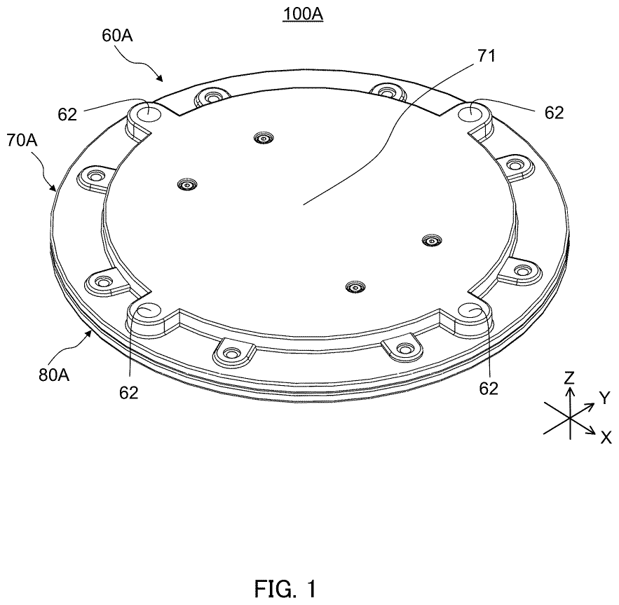

Vibration device 100A according to the present embodiment is described below with reference to FIGS. 1 to 7.

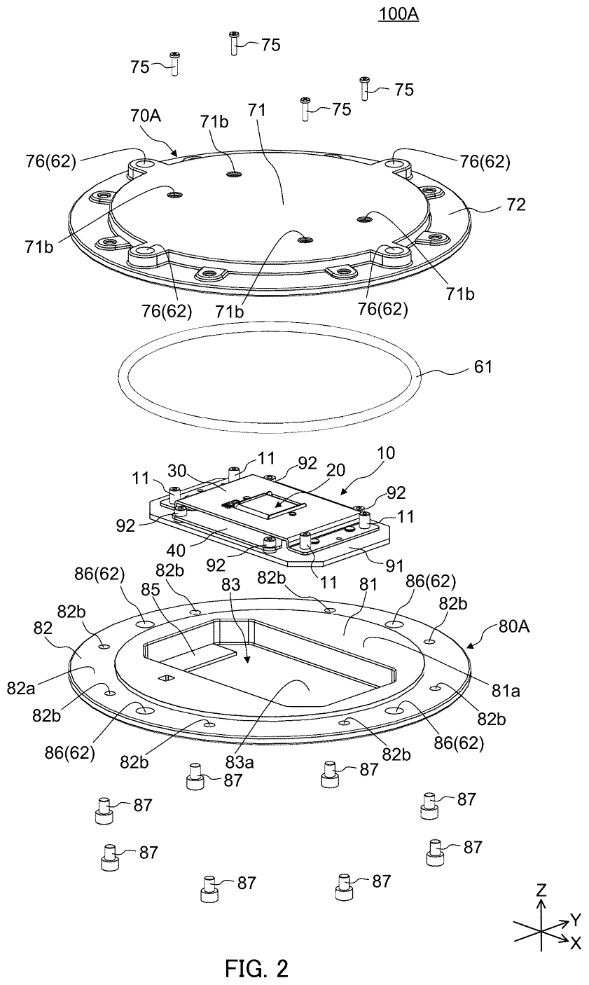

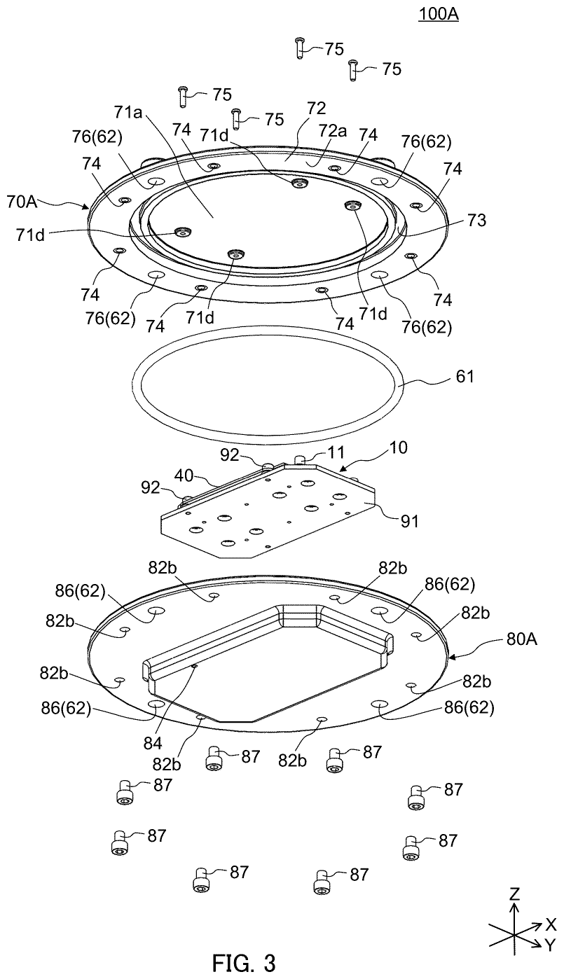

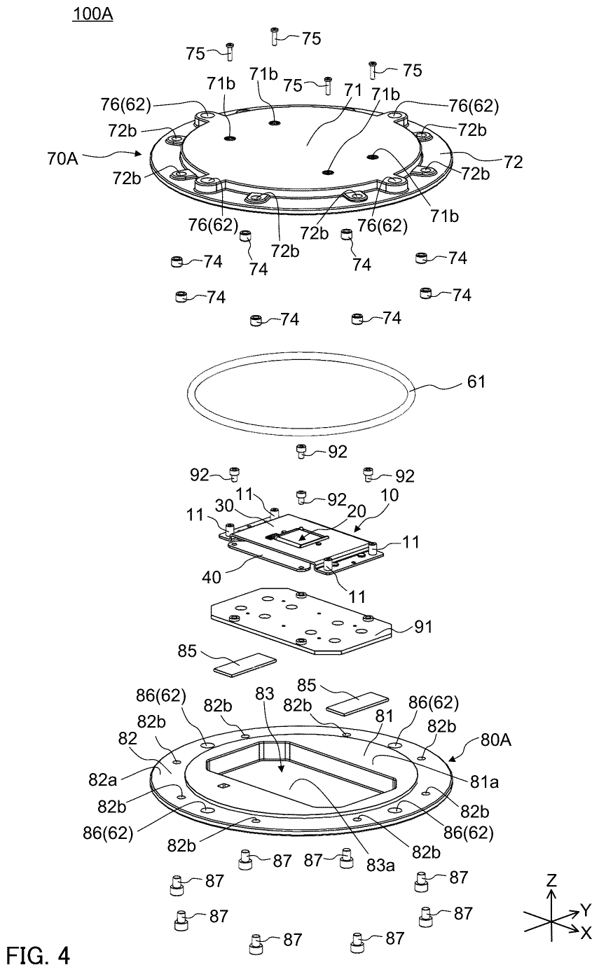

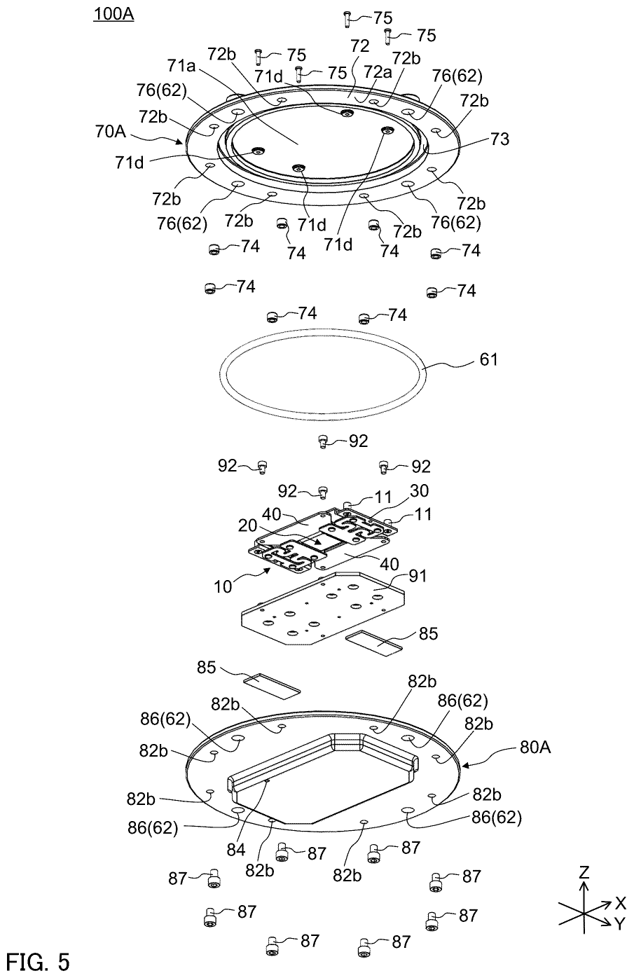

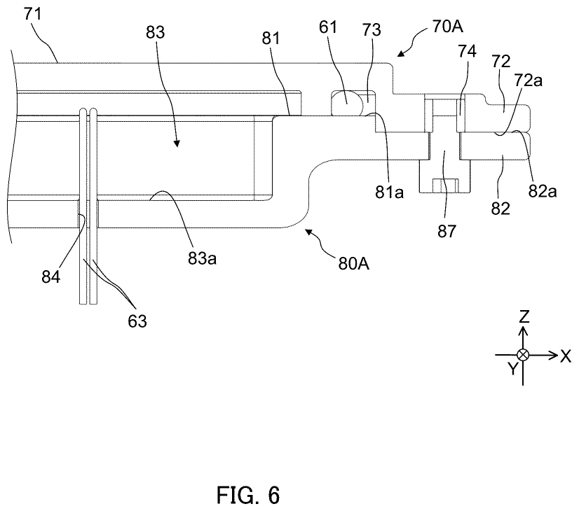

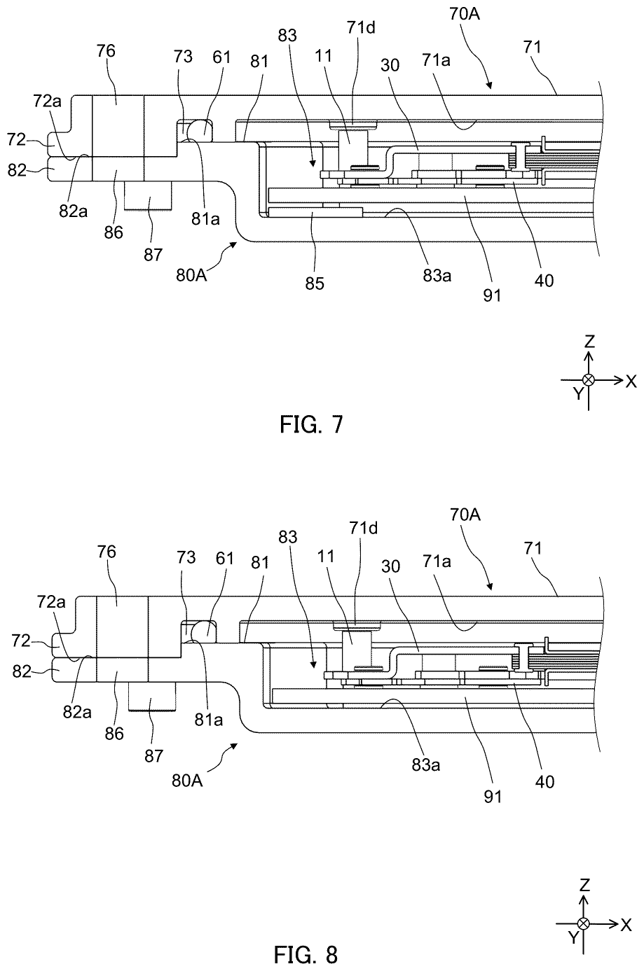

FIG. 1 is a perspective view illustrating vibration device 100A. FIG. 2 is an exploded perspective view of a main configuration of vibration device 100A, as viewed from an obliquely upper side. FIG. 3 is an exploded perspective view of a main configuration of vibration device 100A, as viewed from an obliquely lower side. FIG. 4 is another exploded perspective view of a part of vibration device 100A illustrated in FIG. 2, as viewed from an obliquely upper side. FIG. 5 is another exploded perspective view of a part of vibration device 100A illustrated in FIG. 3, as viewed from an obliquely lower side. FIG. 6 is an enlarged view of a cable portion connected to electromagnetic actuator 10 provided in vibration device 100A. FIG. 7 is a diagram for describing a part of the inside of vibration device 100A.

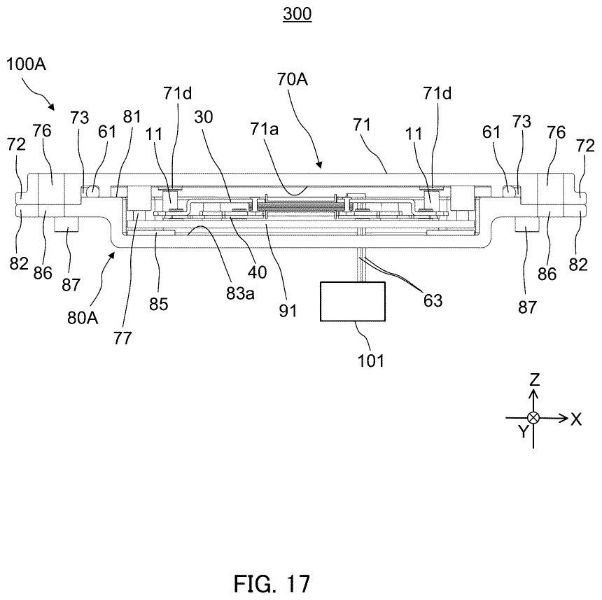

Vibration device 100A illustrated in FIGS. 1 to 7 includes electromagnetic actuator 10 as an example of the vibration actuator, and applies to the vibration object the vibration generated in electromagnetic actuator 10 in accordance with the input driving signal. Note that the driving signal is described later with reference to FIGS. 17 to 22.

Vibration device 100A is disposed in an environment such as outdoors exposed to wind and rain to apply vibration to the vibration object, for example. For example, as illustrated in FIG. 33 described later, vibration unit 300F including vibration device 100A is disposed at roof 401 of house 400, and used as a snow accumulation countermeasure for dropping the snow accumulation from roof 401 by applying vibration to the snow accumulation on roof 401.

As such, to enable installation regardless of the surrounding environment, vibration device 100A includes electromagnetic actuator 10 and housing part 60A, and electromagnetic actuator 10 is housed and sealed inside housing part 60A as illustrated in FIGS. 2 to 5. In addition, movable panel 91 serving as a weight member is attached to electromagnetic actuator 10.

### Housing Part 60A

As illustrated in FIGS. 2 to 5, housing part 60A includes housing lid part 70A, housing base part 80A, and sealing member 61. Sealing member 61 is interposed between housing lid part 70A and housing base part 80A, and housing base part 80A is fixed to housing lid part 70A by threadedly engaging screw 87 as a securing member with insert nut 74 of housing lid part 70A through housing base part 80A. This structure seals the inner space of housing part 60A, i.e., the space between housing lid part 70A and housing base part 80A. Electromagnetic actuator 10 is sealed and housed in the above-described space, and attached to housing lid part 70A that applies vibration to the external vibration object through support column 11.

Housing part 60A is formed in a cylindrical shape, for example. By forming housing part 60A in a cylindrical shape, a ring-shaped gasket, an O-ring and the like may be used as sealing member 61, for example. With such a shape, the force of pressing sealing member 61 is equally dispersed between housing lid part 70A and housing base part 80A. In this manner, the part between housing lid part 70A and housing base part 80A can be stably sealed over the whole circumference of sealing member 61, and stable waterproofness can be achieved. In addition, in vibration device 100A, electromagnetic actuator 10 is sealed and housed inside housing part 60A, and thus the driving sound of electromagnetic actuator 10 is not leaked to the outside, and, vibration device 100A can be provided as a device with a small driving sound.

In this manner, the inside of housing part 60A can be waterproofed, and defects as such short circuit of electromagnetic actuator 10, rust on the components and the like can be prevented. Further, the environmental resistance of vibration device 100A can be increased, and it is thus possible to provide vibration device 100A that can apply vibration to the vibration object regardless of the surrounding environment. In addition, since it is easy to form groove part 73 for placing sealing member 61 and the like, the manufacturing cost can be reduced.

When electromagnetic actuator 10 housed inside housing part 60A is continuously driven, coil 22 described later making up electromagnetic actuator 10 may possibly generate heat. In the present embodiment, even if coil 22 generates heat, the vibration object to which the vibration is applied does not make direct contact with coil 22 since electromagnetic actuator 10 is housed inside housing part 60A (housing lid part 70A and housing base part 80A). In this manner, safety can be ensured by preventing the influence of the generated heat on the vibration object.

Note that while housing part 60A is formed in a cylindrical shape in this case, the shape may be changed as necessary in accordance with the vibration object to which the vibration is applied and the like, and may be changed to a rectangular cylindrical shape and the like.

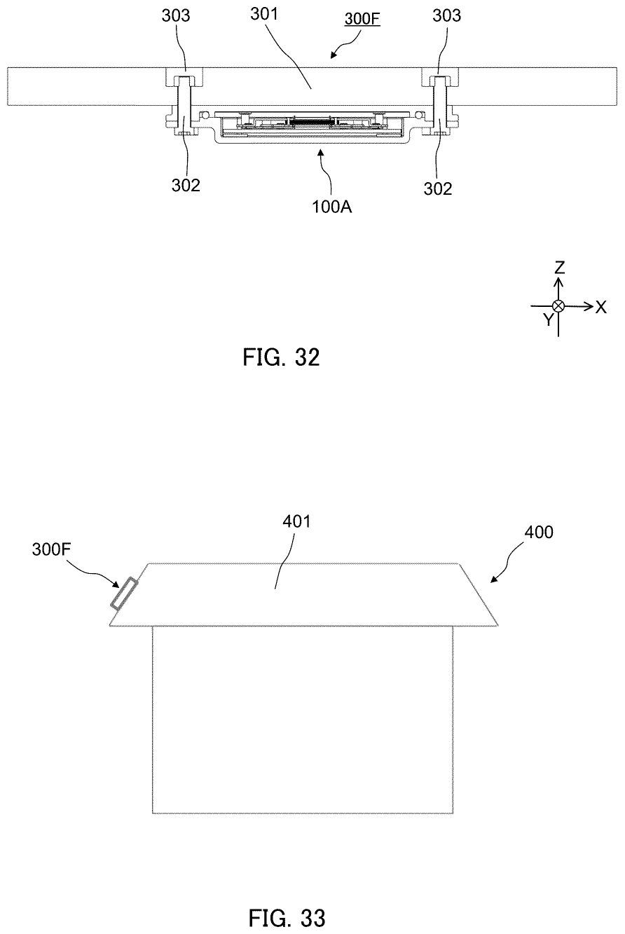

In addition, housing part 60A may include insertion hole 62 for insertion of a screw for attaching the vibration object. For example, as illustrated in FIG. 32 described later, rubber mat 301 may be attached to housing part 60A by inserting screw 302 for attaching rubber mat 301 as a vibration object into insertion hole 62.

### Housing Lid Part 70A

As illustrated in FIGS. 2 to 5, housing lid part 70A includes vibration transmitting part 71, lid flange 72, and groove part 73. Vibration transmitting part 71, lid flange 72 and groove part 73 are integrally formed in order to seal the inner space of housing part 60A.

Vibration transmitting part 71 is a flat surface for transmitting vibration to the external vibration object, and electromagnetic actuator 10 is attached to inner wall 71a of vibration transmitting part 71 with fixing body 30 or movable body 40 therebetween. Vibration transmitting part 71 is disposed on the inner periphery side of outermost lid flange 72 where base flange 82 of housing base part 80A is attached. In addition, vibration transmitting part 71 is disposed on the plus side of lid flange 72 in the Z direction and separated from lid flange 72 so as not to make contact with housing base part 80A side. With such a structure, vibration transmitting part 71 where electromagnetic actuator 10 is attached makes contact with the external vibration object, and functions as a vibration transmission surface that transmits vibration. Vibration transmitting part 71 corresponds to the contact part of the present invention.

Here, for example, screw 75 as a securing member is inserted into insertion hole 71b of vibration transmitting part 71 from the outside to the inside, and thus the screw 75 is threadedly engaged with support column 11 of electromagnetic actuator 10. In this manner, electromagnetic actuator 10 is attached to inner wall 71a through support column attaching part 71d protruding from inner wall 71a. In this case, after electromagnetic actuator 10 is attached by means of screw 75, the portion of insertion hole 71b is sealed with a sealing member such as sealing materials and caulking materials, and thus waterproofness is ensured, for example.

Note that electromagnetic actuator 10 may be attached to inner wall 71a by embedding an insert nut in inner wall 71a and threadedly engaging a screw to the insert nut from inner wall 71a side without providing insertion hole 71b in vibration transmitting part 71, for example.

Lid flange 72 is a portion to which base flange 82 is attached, and is disposed on the outer periphery side of vibration transmitting part 71. In addition, a plurality of insert nuts 74 is embedded in lid part attachment surface 72a as a surface where lid flange 72 is attached to base flange 82, and screw 87 is threadedly engaged with insert nut 74 when housing base part 80A is fixed to housing lid part 70A.

The plurality of insert nuts 74 is disposed at even distances in the circumferential direction of lid part attachment surface 72a. With such an arrangement, the force of pressing sealing member 61 is equally dispersed between housing lid part 70A and housing base part 80A. In this manner, the part between housing lid part 70A and housing base part 80A can be stably sealed over the whole circumference of sealing member 61, and stable waterproofness can be achieved.

Groove part 73 is disposed on the inner circumference side than the position where insert nut 74 is disposed in lid part attachment surface 72a. When sealing member 61 is inserted into groove part 73 and sealing member 61 is pressed between groove part 73 and pressing part 81 of housing base part 80A, the part between housing lid part 70A and housing base part 80A is sealed.

To provide the above-described insertion hole 62 in housing part 60A, lid flange 72 is provided with lid through hole 76 formed to extend through the lid flange 72 in housing lid part 70A. Lid through hole 76 is disposed corresponding to base through hole 86 of housing base part 80A. When housing base part 80A is fixed to housing lid part 70A, lid through hole 76 and base through hole 86 are combined, and thus insertion hole 62 is formed.

### Housing Base Part 80A

As illustrated in FIGS. 2 to 5, housing base part 80A includes pressing part 81, base flange 82, and housing recess 83. Pressing part 81, base flange 82 and housing recess 83 are integrally formed to seal the inner space of housing part 60A.

Pressing part 81 is a surface for pressing sealing member 61 inserted inside groove part 73 of housing lid part 70A. Pressing part 81 is disposed on the inner periphery side of outermost base flange 82 where lid flange 72 of housing lid part 70A is attached. In addition, pressing part 81 is formed to protrude to the plus side in the Z direction from base part attachment surface 82a that is the surface where base flange 82 is attached to lid flange 72, so as to fit inside lid flange 72.

Pressing part 81 is disposed and formed in the above-described manner, and sealing member 61 inserted inside groove part 73 is pressed with pressing part 81 such that the part between housing lid part 70A and housing base part 80A is sealed. Basically, vibration device 100A is disposed with housing lid part 70A on the upper side, and housing base part 80A on the lower side. In this case, as illustrated in FIG. 7, lid part attachment surface 72a and base part attachment surface 82a are located on the outside (in the X direction and the Y direction) of the position where sealing member 61 is disposed to surround electromagnetic actuator 10 provided inside housing part 60A. Further, a step structure in which contact surface 81a of pressing part 81 and sealing member 61 is located at a position (a position on the plus side in the Z direction) higher than lid part attachment surface 72a and base part attachment surface 82a is provided, and thus entry of moisture and the like to contact surface 81a side can be suppressed. In this manner, the inside of housing part 60A can be waterproofed, and defects such as short circuit of electromagnetic actuator 10, rust on the components and the like can be prevented.

Base flange 82 is a portion where lid flange 72 is attached, and is disposed on the outer periphery side of pressing part 81. In addition, a plurality of insertion holes 82b is provided in base flange 82, and screw 87 is inserted to insertion hole 82b and threadedly engaged with insert nut 74 when housing base part 80A is fixed to housing lid part 70A.

The plurality of insertion holes 82b is disposed at even distances in the circumferential direction of base flange 82 in a manner corresponding to the arrangement of the plurality of insert nuts 74, for example. With such an arrangement, the force of pressing sealing member 61 is equally dispersed between housing lid part 70A and housing base part 80A. In this manner, the part between housing lid part 70A and housing base part 80A can be stably sealed over the whole circumference of sealing member 61, and stable waterproofness can be achieved.

Housing recess 83 is a recess provided in a recessed manner on the inner periphery side of pressing part 81 to house electromagnetic actuator 10 attached to housing lid part 70A side. Housing recess 83 is formed to be larger than the size of electromagnetic actuator 10 so as not to interfere with the vibration of electromagnetic actuator 10, and the inside of housing recess 83 is formed in a substantially cuboid shape to match the shape of electromagnetic actuator 10. Note that the shape, size and the like of housing recess 83 may be changed as necessary in accordance with the shape, size and the like of electromagnetic actuator 10.

As also illustrated in FIG. 7, impact absorbing part 85 (the limiting part in the present invention) facing movable panel 91 of electromagnetic actuator 10 is provided at bottom surface 83a of housing recess 83. Here, impact absorbing part 85 is provided at two locations in bottom surface 83a so as to face both end portions of movable panel 91 in the X direction. Impact absorbing part 85 is composed of a damper formed of an elastomer, for example. When movable panel 91 makes contact with impact absorbing part 85, the movement (protrusion) of movable panel 91 to the plus side in the Z direction during the vibration is suppressed, and the impact of movable panel 91 is absorbed.

In this manner, with impact absorbing part 85, the movable range of movable panel 91 to the minus side in the Z direction is limited. For example, in the case where vibration device 100A is mistakenly dropped, if the movable range of movable panel 91 is not of limited, elastic part 50 electromagnetic actuator 10 described later may be plastically deformed or damaged due to the impact of the drop. On the other hand, in the present embodiment, the movable range of movable panel 91 to the minus side in the Z direction is limited, and thus plastic deformation and damage of elastic part 50 can be prevented.

In addition, if the impact from movable panel 91 is strong and housing base part 80A directly receives the impact, housing base part 80A may be cracked and damaged. On the other hand, in the present embodiment, the impact of movable panel 91 is received by impact absorbing part 85 to absorb the impact, and thus the damages to housing base part 80A can be prevented.

In addition, hole 84 extending through bottom surface 83a is provided at bottom surface 83a of housing recess 83 as also illustrated in FIG. 6. Cable 63 for supplying a driving signal to coil 22 of electromagnetic actuator 10 is inserted to through hole 84, and, after cable 63 is inserted, the portion of through hole 84 is sealed with a sealing member such as sealing materials and caulking materials, and thus waterproofness is ensured, for example.

To provide the above-described insertion hole 62 in housing part 60A, base through hole 86 extending through the base flange 82 is formed in base flange 82 in housing base part 80A. Base through hole 86 is disposed corresponding to lid through hole 76 of housing lid part 70A. When housing base part 80A is fixed to housing lid part 70A, lid through hole 76 and base through hole 86 are combined, and insertion hole 62 is formed.

### Movable Panel 91

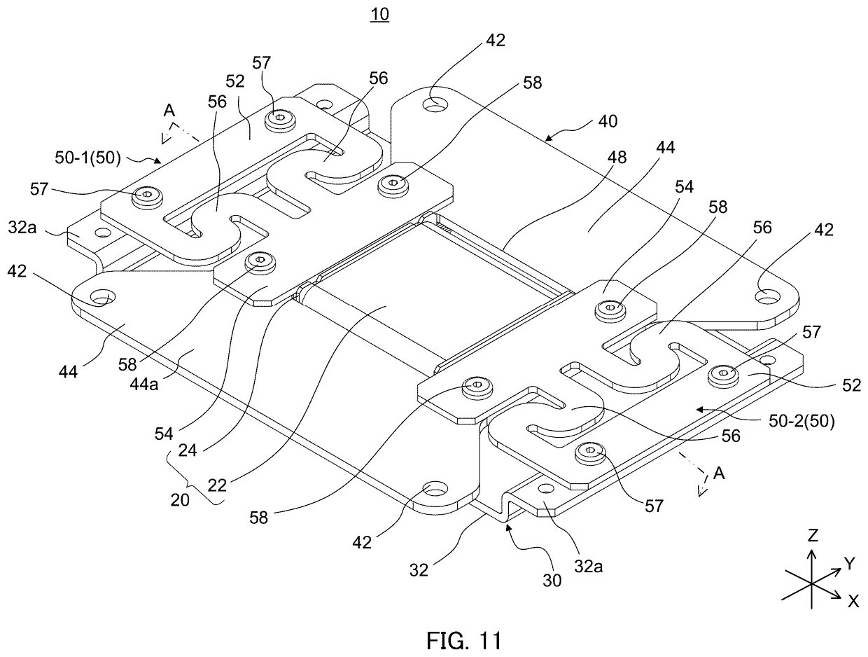

While electromagnetic actuator 10 will be described later with reference to FIGS. 11 to 16, electromagnetic actuator 10 is attached to inner wall 71a of vibration transmitting part 71 via cylindrical support column 11 extending in one direction (the Z direction) of the vibration direction of movable body 40. Support column 11 corresponds to the supporting member in the present invention. Here, electromagnetic actuator 10 is disposed with fixing body 30 side facing inner wall 71a and movable body 40 side facing bottom surface 83a of housing base part 80A.

Movable panel 91 is attached to movable body 40 disposed in the above-described manner by means of screw 92 as a securing member through a spacer (whose reference numeral is omitted). Here, as illustrated in FIG. 11 described later and the like, surface part fixing hole 42 is formed at the four corners of surface part fixing part 44 of movable body 40 (yoke 41), and screw 92 is inserted to surface part fixing hole 42 and the spacer and threadedly engaged with the screw hole (whose reference numeral is omitted) of movable panel 91.

By fixing movable panel 91 to movable body 40 in this manner, movable panel 91 vibrates together with movable body 40. Further, the vibration of movable body 40 is transmitted to vibration transmitting part 71 through support column 11 extending along the Z direction. The vibration direction of movable body 40 is the Z direction, support column 11 that transmits the vibration of movable body 40 is set along the Z direction, and the Z direction is the direction perpendicular to the surface of vibration transmitting part 71 that transmits the vibration to the vibration object. Since the vibration direction of the vibration of movable body 40 is set to the direction perpendicular to the surface of transmitting part 71, vibration transmitting part 71 can be driven by stronger vibration than when the direction is not the direction perpendicular to the surface. Further, by attaching to movable body 40 movable panel 91 functioning as a weight of vibrated movable body 40, the vibration transmitted to vibration transmitting part 71 can be made stronger.

Desirably, movable panel 91 has a flat shape in view of the height reduction and thickness reduction of vibration device 100A. In addition, movable panel 91 is provided with an opening (whose reference numeral is omitted) at a position corresponding to the position of screws 57 and 58 of electromagnetic actuator 10 described later. When movable panel 91 is attached to movable body 40, screws 57 and 58 are disposed in the opening, and thus the increase of the length (thickness) of electromagnetic actuator 10 and movable panel 91 in the Z direction can be suppressed.

Note that the shape, material, configuration and the like of movable panel 91 are not limited as long as it can be attached to movable body 40 and can function as a weight.

### Variation 1 of Vibration Device 100A

In the present embodiment, as illustrated in FIG. 7, vibration device 100A includes impact absorbing part 85 at bottom surface 83a (corresponding to the inner wall in the present invention) of housing base part 80A on the minus side of movable panel 91 in the Z direction, but vibration device 100A may be configured without impact absorbing part 85. For example, as illustrated in FIG. 8, vibration device 100A may be configured without impact absorbing part 85.

In the configuration illustrated in FIG. 8, bottom surface 83a (the limiting part in the present invention) of housing base part 80A suppresses the movement of movable panel 91 to the minus side in the Z direction during the vibration. In this case, the thickness of bottom surface 83a, the thickness of movable panel 91 or the height of housing recess 83 is adjusted such that bottom surface 83a can suppress the movement of movable panel 91 to the minus side in the Z direction.

### Variation 2 of Vibration Device 100A

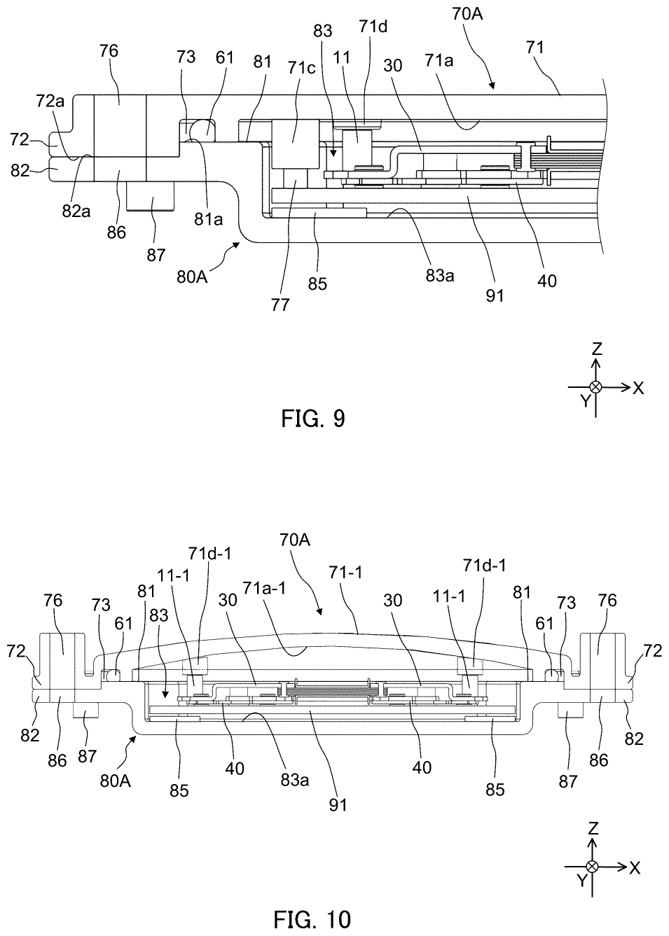

In the present embodiment, as illustrated in FIG. 7, vibration device 100A includes impact absorbing part 85 on the minus side of movable panel 91 in the Z direction, but the impact absorbing part may be provided also on the plus side of movable panel 91 in the Z direction. For example, as illustrated in FIG. 9, vibration device 100A may include impact absorbing part 77 (the limiting part in the present invention) in addition to impact absorbing part 85.

Here, projecting part 71c is provided to protrude to the minus side in the Z direction at inner wall 71a of vibration transmitting part 71, and impact absorbing part 77 is provided at the surface of projecting part 71c on the minus side in the Z direction. In addition, in this case, impact absorbing part 77 and projecting part 71c are provided at two locations in inner wall 71a to face both end portions of movable panel 91 in the X direction.

In the configuration illustrated in FIG. 9, regarding the movement of movable panel 91 to the minus side in the Z direction during the vibration, impact absorbing part 85 suppresses the movement and absorbs the impact of movable panel 91 as in the configuration illustrated in FIG. 7. Regarding the movement of movable panel 91 to the plus side in the Z direction during the vibration, impact absorbing part 77 suppresses the movement and absorbs the impact of movable panel 91. In addition, by providing impact absorbing part 77 in addition to impact absorbing part 85, unnecessary vibration of movable body 40 and movable panel 91 is suppressed, and vibration with significant attenuation can be provided when vibration with significant attenuation is required. For example, the thicknesses of impact absorbing part 85, projecting part 71c, and impact absorbing part 77 are adjusted such that impact absorbing part 85 and impact absorbing part 77 can suppress the movement of movable panel 91 in the Z direction, and attenuate the vibration.

### Variation 3 of Vibration Device 100A

In the present embodiment, vibration transmitting part 71 of vibration device 100A is formed in a flat shape as illustrated in FIGS. 1 to 7. The vibration transmitting part is not limited to this, and may be a curved surface with a center portion protruding to the outside (the plus side in the Z direction) as with vibration transmitting part 71-1 (corresponding to the contact part in the present invention) illustrated in FIG. 10. In this case, inner wall 71a-1 of vibration transmitting part 71-1 is a curved surface with a center portion recessed to the outside (the plus side in the Z direction) in a manner corresponding to the curved surface of vibration transmitting part 71-1.

In this manner, inner wall 71a-1 is a curved surface recessed to the plus side in the Z direction. Thus, support column attaching part 71d-1 provided to protrude from inner wall 71a-1 and attach support column 11-1 is extended from inner wall 71a-1 to the minus side in the Z direction in comparison with support column attaching part 71d for attaching support column 11. Electromagnetic actuator 10 is attached to inner wall 71a-1 through support column attaching part 71d-1.

For example, in the case where rubber mat 301 as a vibration object is attached to both ends of vibration device 100A and vibration is desirably stably transmitted also at its center portion as illustrated in FIG. 32 described later, a configuration including vibration transmitting part 71-1 with a center portion protruding to the outside is adopted.

Since rubber mat 301 is attached (fixed) to both ends of vibration device 100A, vibration can be stably transmitted from vibration transmitting part 71 to rubber mat 301 at both end portions. Further, with vibration transmitting part 71-1 with a center portion protruding to the outside, a contact with rubber mat 301 can be ensured at the center portion of vibration transmitting part 71-1 even in the case where the rigidity of rubber mat 301 is low. In this manner, vibration transmitting part 71-1 can stably vibrate the vibration object such as rubber mat 301 by ensuring the contact with the vibration object and stably transmitting the vibration.

### Electromagnetic Actuator 10

Electromagnetic actuator 10 provided in vibration device 100A is described below with reference to FIGS. 11 to 14.

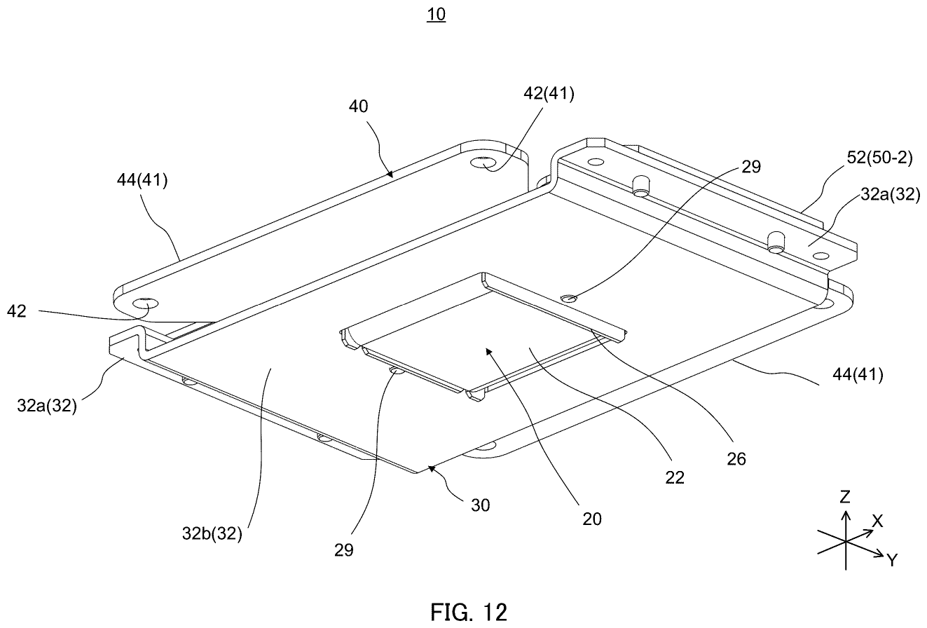

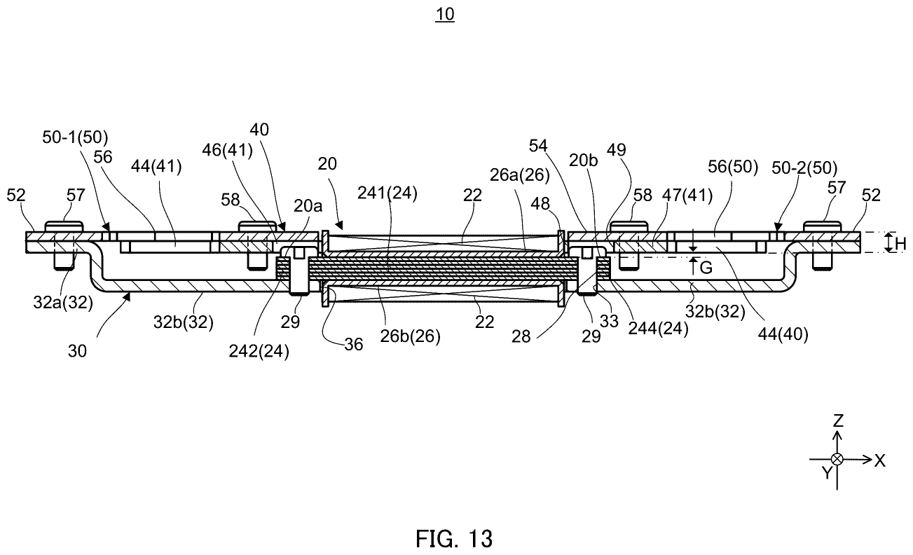

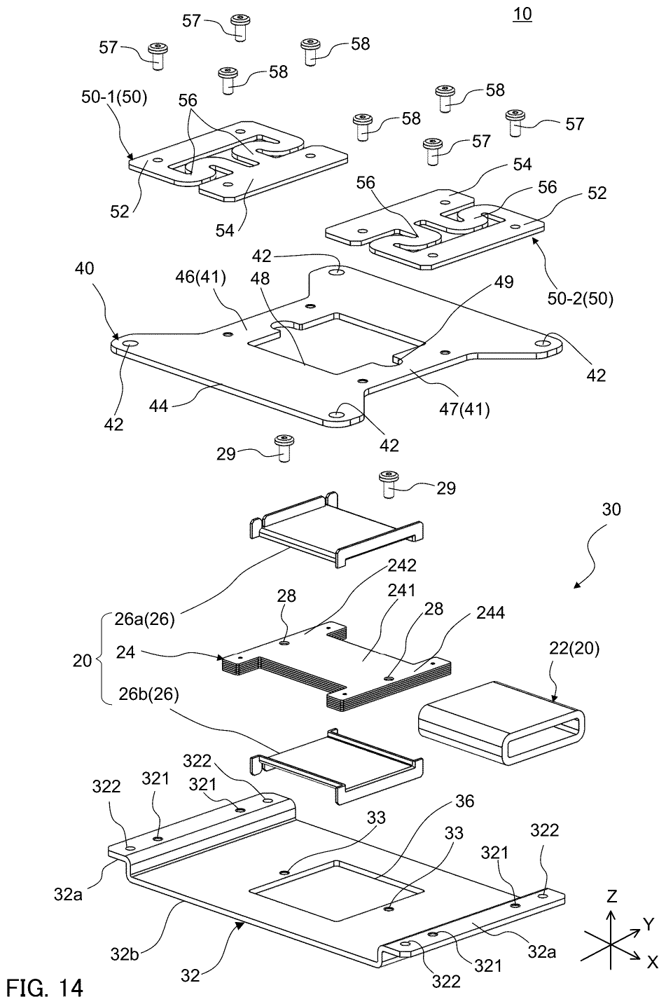

FIG. 11 is a perspective view of electromagnetic actuator 10 provided in vibration device 100A, as viewed from an obliquely upper side. FIG. 12 is a perspective view of electromagnetic actuator 10, as viewed from an obliquely lower side. FIG. 13 is a sectional view of electromagnetic actuator 10 illustrated in FIG. 11 taken along line A-A. FIG. 14 is an exploded perspective view of electromagnetic actuator 10.

Electromagnetic actuator 10 functions as a vibration generation source of vibration transmitting part 71 (see FIGS. 1 to 7), and transmits the vibration according to the input driving signal to the vibration object.

Electromagnetic actuator 10 includes fixing body 30 and movable body 40 where movable panel 91 is fixed. Movable body 40 is supported through elastic part 50 such that it can elastically vibrate to with respect fixing body 30. Electromagnetic actuator 10 linearly moves movable body 40 back and forth by driving movable body 40 in one direction and moving movable body 40 in the direction opposite to the one direction with the biasing force of elastic part 50 for generating a biasing force.

Here, the driving in one direction means driving movable body 40 in one direction of the vibration direction by exciting coil 22 described later at movable body 40 supported through elastic part 50 in a movable manner in the vibration direction with respect to fixing body 30. When movable body 40 is driven in one direction of the vibration direction in this manner, movable body 40 moves in the direction opposite to the one direction with the biasing force of elastic part 50 after the driving. Movable body 40 is vibrated by repeating such driving. The vibration of movable body 40 generated in the above-described manner provides very quick responsiveness up to the generation of the vibration after the input of the driving signal to coil 22.

As elaborated later, fixing body 30 includes core assembly 20 composed of coil 22 wound around core 24, and base part 32. In addition, movable body 40 includes yoke 41 composed of a magnetic member. Elastic part 50 (50-1, 50-2) elastically supports movable body 40 such that movable body 40 is movable in the vibration direction with respect to fixing body 30.

Electromagnetic actuator 10 drives, to move in one direction, movable body 40 movably supported by elastic part 50 with respect to fixing body 30. In addition, movable body 40 is moved in the direction opposite to the one direction with the biasing force of elastic part 50.

Specifically, electromagnetic actuator 10 vibrates yoke 41 of movable body 40 by means of core assembly 20. More specifically, movable body 40 is vibrated with the attraction force of energized coil 22 and core 24 excited by energized coil 22, and the biasing force of elastic part 50 (50-1, 50-2). In the present embodiment, electromagnetic actuator 10 is driven by the action of the electromagnet.

In addition, electromagnetic actuator 10 is configured in a flat shape with the Z direction as the thickness direction. Electromagnetic actuator 10 vibrates movable body 40 with respect to fixing body 30 in the Z direction, i.e., the thickness direction, as the vibration direction. In this manner, in electromagnetic actuator 10, one of the front and rear members (fixing body 30 and movable body 40) separated in the thickness direction of electromagnetic actuator 10 itself is brought closer to and separated from the other in the Z direction.

In the present embodiment, electromagnetic actuator 10 moves movable body 40 to the minus side in the Z direction as one direction with the attraction force of core 24, and moves movable body 40 to the plus side in the Z direction with the biasing force of elastic part 50 (50-1, 50-2).

In electromagnetic actuator 10 of the present embodiment, movable body 40 is elastically supported by a plurality of elastic parts 50 (50-1, 50-2) disposed along the direction orthogonal to the Z direction at a position point symmetrical with respect to the movement center of movable body 40.

### Fixing Body 30

As illustrated in FIGS. 13 and 14, fixing body 30 includes core assembly 20 including coil 22 and core 24, and base part 32.

Base part 32, to which core assembly 20 is fixed, supports movable body 40 through elastic part 50 (50-1, 50-2) such that movable body 40 can freely vibrate. Base part 32 is a member with a flat shape, and forms the bottom surface of electromagnetic actuator 10. Base part 32 includes, with core assembly 20 sandwiched therebetween, attaching parts 32a to which one end portion of elastic parts 50 (50-1, 50-2) is fixed. Attaching parts 32a are disposed with the same distance from core assembly 20. Note that this distance serves as the deformation region of elastic part 50 (50-1, 50-2).

As illustrated in FIG. 14, attaching part 32a includes fixing hole 321 for fixing elastic part 50 (50-1, 50-2), and fixing hole 322 for attaching support column 11. Fixing hole 322 is provided at both end portions of attaching part 32a with fixing hole 321 sandwiched therebetween, and each attached to inner wall 71a of vibration transmitting part 71 through support column 11 as illustrated in FIGS. 2 to 5 and 7.

In the present embodiment, base part 32 is configured by processing a sheet metal such that one side portion and the other side portion as attaching parts 32a are separated from each other in the width direction (the X direction) with bottom surface part 32b sandwiched therebetween. A recessed part including bottom surface part 32b with a lower height than attaching part 32a is provided between attaching parts 32a. The inside of the recessed part, i.e., the space on the front surface side of bottom surface part 32b is for ensuring the elastic deformation region of elastic part 50 (50-1, 50-2), and is a space for ensuring the movable region of movable body 40 supported by elastic part 50 (50-1, 50-2).

Bottom surface part 32b has a rectangular shape, and opening 36 is formed at its center portion. Core assembly 20 is located inside opening 36.

Core assembly 20 is fixed inside opening 36 in a partially inserted state. More specifically, divided member 26b of bobbin 26 on the lower side of core assembly 20 and a lower portion of coil 22 are inserted inside opening 36, and fixed such that core 24 is located above bottom surface part 32b in side view.

In this manner, the length in the Z direction is smaller (the thickness is smaller) in comparison with the configuration in which core assembly 20 is attached above bottom surface part 32b. In addition, a part of core assembly 20, or in this case a part of the bottom surface side, is fixed in the state of being fit in opening 36, and thus core assembly 20 is firmly fixed in the state where it is less detached from bottom surface part 32b.

Opening 36 has a shape corresponding to the shape of core assembly 20. In the present embodiment, opening 36 is formed in a square shape. In this manner, electromagnetic actuator 10 can have a substantially square shape in its entirety in plan view with core assembly 20 and movable body 40 disposed at a center portion of electromagnetic actuator 10. Note that opening 36 may have a rectangular shape (including a square shape).

Core assembly 20 vibrates (linearly moves back and forth) yoke 41 of movable body 40 in the Z direction in conjunction with elastic part 50 (50-1, 50-2).

In the present embodiment, core assembly 20 is formed in a rectangular plate-shape, and magnetic pole parts 242 and 244 are disposed at both side portions separated in the longitudinal direction (the X direction) in the rectangular plate-shape.

Magnetic pole parts 242 and 244 are disposed close to the bottom surfaces of attracted surface parts 46 and 47 of movable body 40 so as to face the bottom surfaces with gap G (see FIG. 13) therebetween in the Z direction. In magnetic pole parts 242 and 244, the opposing surfaces (opposing surface part) 20a and 20b as the top surfaces face the bottom surfaces of attracted surface parts 46 and 47 of yoke 41 in the vibration direction of movable body 40.

Core assembly 20 is configured with coil 22 wound around the outer periphery of core 24 through bobbin 26. As illustrated in FIGS. 13 and 14, core assembly 20 is fixed to base part 32 with the winding axis of coil 22 set in the direction in which attaching parts 32a separated in base part 32 face each other. In the present embodiment, core assembly 20 is disposed at a center portion of base part 32, or more specifically at a center portion of bottom surface part 32b.

As illustrated in FIG. 13, core assembly 20 is fixed to bottom surface part 32b such that core 24 is located parallel to bottom surface part 32b across opening 36 on the bottom surface. Core assembly 20 is fixed with screw 29 as a securing member in the state where coil 22 and the portion (core body 241) wound around coil 22 are located inside opening 36 of base part 32 (see FIGS. 12 to 14).

More specifically, core assembly 20 is fixed to bottom surface part 32b in the state where coil 22 is disposed inside opening 36 by fastening screw 29 through fixing hole 28 and securing hole 33 of bottom surface part 32b (see FIG. 14). Core assembly 20 and bottom surface part 32b are joined at two locations on the axial core of coil 22 with coil 22 therebetween by means of screw 29 at both sides of opening 36 separated in the X direction and magnetic pole parts 242 and 244.

Coil 22 is a solenoid that generates a magnetic field by being energized when driving electromagnetic actuator 10. Together with core 24 and movable body 40, coil 22 makes up a magnetic circuit (magnetic path) for pulling and moving movable body 40. When a driving signal is supplied to coil 22 from drive control parts 110A to 110E (see FIGS. 17 to 21) described later, the power is supplied to coil 22, and thus electromagnetic actuator 10 is driven.

Core 24 includes core body 241 around which coil 22 is wound, and magnetic pole parts 242 and 244 disposed at both end portions of core body 241 and configured to be excited through energization of coil 22.

The structure of core 24 is not limited as long as the structure has a length with which both end portions serve as magnetic pole parts 242 and 244 through energization of coil 22. For example, core 24 of the present embodiment is formed in an H-shaped plate shape in plan view although it may be formed in a straight-shaped (I-shaped) plate shape. In comparison with the I-shaped core, the H-shaped core has a shape in which the gap side surface is elongated and extended in the front-rear direction (the Y direction) at both end portions of core body 241 than the width of the core body around which coil 22 is wound.

In this manner, with the H-shaped core, the efficiency of the magnetic circuit can be improved by reducing the magnetic resistance than using the I-shaped core. In addition, coil 22 can be positioned by only fitting bobbin 26 between the portions extended from core body 241 at magnetic pole parts 242 and 244, and it is thus not necessary to additionally provide the member for positioning bobbin 26 with respect to core 24.

In core 24, magnetic pole parts 242 and 244 are provided to protrude in the direction orthogonal to the winding axis of coil 22 at respective both end portions of plate-shaped core body 241 around which coil 22 is wound.

Core 24 is a magnetic member formed of a silicon steel sheet, permalloy, ferrite or the like, for example. In addition, core 24 may be composed of an electromagnetic stainless-steel, a sintered material, an MIM (metal injection mold) material, a laminated steel sheet, an electro-galvanized steel sheet (SECC) or the like.

Magnetic pole parts 242 and 244 are protruded in the Y direction from both openings of coil 22.

Magnetic pole parts 242 and 244 attract and move yoke 41 of movable body 40 separated in the vibration direction (the Z direction) by being excited through energization to coil 22. More specifically, with the generated magnetic flux, magnetic pole parts 242 and 244 attract attracted surface parts 46 and 47 of movable body 40 disposed in a facing manner with gap G therebetween.

Magnetic pole parts 242 and 244 are plate-shaped members extending in the Y direction, which is the direction perpendicular to core body 241 extending in the X direction. Magnetic pole parts 242 and 244 are elongated in the Y direction, and therefore the areas of opposing surfaces 20a and 20b facing yoke 41 are greater than in a configuration in which they are formed at both end portions of core body 241.

Magnetic pole parts 242 and 244 are provided with fixing hole 28 formed at a center portion in the Y direction, and are fixed to base part 32 by means of screw 29 inserted to fixing hole 28.

Bobbin 26 is disposed to surround core body 241 of core 24. Bobbin 26 is formed of a resin material, for example. In this manner, electric insulation with other metal members (such as core 24) can be ensured, thus improving the reliability as an electric circuit. By using high-flow resins for the resin material, the workability is improved and the thickness can be reduced while ensuring the strength of bobbin 26.

Note that bobbin 26 is formed as a cylindrical member to cover the periphery of core body 241 with divided members 26a and 26b assembled to sandwich core body 241. Note that bobbin 26 is provided with a flange at both end portions of the cylindrical member to define it such that coil 22 is located on the outer periphery of core body 241.

### Movable Body 40

Movable body 40 is disposed in a facing manner at core assembly 20 with gap G therebetween in the direction orthogonal to the vibration direction (the Z direction). Movable body 40 is provided so as to be movable back and forth in the vibration direction with respect to core assembly 20.

Movable body 40 includes yoke 41, and movable body side fixing part 54 of elastic parts 50-1 and 50-2 fixed to yoke 41.

Movable body 40 is disposed through elastic part 50 (50-1, 50-2) so as to be movable in the approaching or separating direction (the Z direction) with respect to bottom surface part 32b in a state of being suspended in an approximately parallel manner with a space therebetween (reference state position).

Yoke 41 is a plate-shaped member composed of a magnetic member such as an electromagnetic stainless-steel, a sintered material, a MIM (metal injection mold) material, a laminated steel sheet, and an electro-galvanized steel sheet (SECC). In the present embodiment, yoke 41 is formed by processing an SECC plate.

With elastic part 50 (50-1, 50-2) fixed to attracted surface parts 46 and 47 separated in the X direction, yoke 41 is suspended in a facing manner with respect to core assembly 20 with gap G (see FIG. 13) therebetween in the vibration direction (the Z direction).

Yoke 41 includes surface part fixing part 44 where movable panel 91 is attached, and attracted surface parts 46 and 47 disposed opposite to magnetic pole parts 242 and 244.

In the present embodiment, yoke 41 is formed in a rectangular frame shape with surface part fixing part 44 and attracted surface parts 46 and 47 surrounding center portion opening 48.

Opening 48 faces coil 22. In the present embodiment, opening 48 is located directly above coil 22, and the opening of opening 48 is formed in a shape to which the portion of coil 22 of core assembly 20 can be inserted when yoke 41 moves to bottom surface part 32b side. With the configuration of yoke 41 including opening 48, the thickness of the entirety of the electromagnetic actuator can be reduced in comparison with the case where no opening 48 is provided.

In addition, since core assembly 20 is located in opening 48, yoke 41 is not disposed near coil 22 in comparison with the distance (gap G) between magnetic pole parts 242 and 244 of core body 241 and attracted surface parts 46 and 47 of yoke 41. Thus, the reduction in conversion efficiency due to the leaked magnetic flux leaked from coil 22 can be suppressed, and high output can be achieved.

Surface part fixing part 44 includes fixing surface 44a for fixing movable panel 91. Fixing surface 44a fixes movable panel 91 at a position surrounding core assembly 20 by means of a screw (whose reference numeral is omitted) as a securing member inserted to surface part fixing hole 42.

Attracted surface parts 46 and 47, where elastic part 50 (50-1, 50-2) is fixed, are attracted by magnetic pole parts 242 and 244 magnetized at core assembly 20.

Movable body side fixing parts 54 of elastic parts 50-1 and 50-2 are fixed in a stacked manner to attracted surface parts 46 and 47, respectively. Attracted surface parts 46 and 47 are provided with notch part 49 for escape of screw 29 of core assembly 20 when moved to bottom surface part 32b side.

In this manner, even when movable body 40 moves to bottom surface part 32b side and attracted surface parts 46 and 47 are brought closer to magnetic pole parts 242 and 244, they do not make contact with screw 29 for fixing magnetic pole parts 242 and 244 to bottom surface part 32b, and thus the movable region of yoke 41 in the Z direction can be correspondingly ensured.

### Elastic Part 50

Elastic part 50 (50-1, 50-2) movably supports movable body 40 with respect to fixing body 30. Elastic part 50 (50-1, 50-2) is configured in an elastically-deformable plate-shape. Elastic part 50 (50-1, 50-2) may not have the plate shape, and may be an elastic body of any shapes and materials as long as movable body 40 driven in one direction in the vibration direction can be supported with respect to fixing body 30.

Elastic part 50 (50-1, 50-2) supports movable body 40 such that the top surface of movable body 40 is at the same height as the top surface of fixing body 30, or on the bottom surface side than the top surface of fixing body 30 (in the present embodiment, the top surface of core assembly 20), and that they are parallel to each other. Note that elastic parts 50-1 and 50-2 are members with shapes symmetric about the center of movable body 40, and are, in the present embodiment, formed in the same manner.

Elastic part 50 sets yoke 41 in an approximately parallel manner and in a facing manner with gap G therebetween with respect to magnetic pole parts 242 and 244 of core 24 of fixing body 30. Elastic part 50 supports movable body 40 such that the bottom surface of movable body 40 is on the bottom surface part 32b side than substantially the same level as the height level of the top surface of core assembly 20 and that it is movable in the vibration direction.

In this case, elastic part 50 is a leaf spring including fixing body side fixing part 52, movable body side fixing part 54, and meandering elastic arm part 56 that bridges between fixing body side fixing part 52 and movable body side fixing part 54, for example.

Elastic part 50 attaches movable body 40 by attaching fixing body side fixing part 52 to the surface of attaching part 32a, and attaching movable body side fixing part 54 to the surfaces of attracted surface parts 46 and 47 of yoke 41 such that meandering elastic arm part 56 is parallel to bottom surface part 32b.

Fixing body side fixing part 52 is fixed in surface contact with attaching part 32a by means of screw 57, and movable body side fixing part 54 is fixed in surface contact with attracted surface parts 46 and 47 by means of screw 58.

Meandering elastic arm part 56 is an arm part with a meandering shape part. With the meandering shape part, meandering elastic arm part 56 ensures a length that allows for deformation required for the vibration of movable body 40 at the surface orthogonal to the vibration direction (the surface formed in the X direction and the Y direction) between fixing body side fixing part 52 and movable body side fixing part 54.

In the present embodiment, meandering elastic arm part 56 is extended and folded in the opposing direction of fixing body side fixing part 52 and movable body side fixing part 54, the end portions joined to fixing body side fixing part 52 and movable body side fixing part 54 are shifted in the Y direction. Meandering elastic arm part 56 is disposed at a position point symmetrical or line symmetrical about the center of movable body 40.

In this manner, movable body 40 is supported on both sides by means of meandering elastic arm part 56 including the spring with the meandering shape, and thus stress dispersion during elastic deformation can be achieved. That is, elastic part 50 can move movable body 40 in the vibration direction (the Z direction) without tilting it with respect to core assembly 20, and thus the reliability of the vibration state can be improved.

Each elastic part 50 includes at least two meandering elastic arm parts 56. In this manner, in comparison with the case where one meandering elastic arm part 56 is provided in each part, the stress during elastic deformation is dispersed, and the reliability can be improved, and, the balance of the support for movable body 40 is improved, thus improving the stability.

The leaf spring serving as elastic part 50 may be either non-magnetic or magnetic. In addition, movable body side fixing part 54 of elastic part 50 is disposed at the opposite position or the position on the upper side in the winding axis direction of coil 22 with respect to both end portions (magnetic pole parts 242 and 244) of core 24, and makes up a magnetic path together with core 24 when coil 22 is energized.

In the case where elastic part 50 is composed of a magnetic member, movable body side fixing part 54 is fixed in a stacked manner on the upper side of attracted surface parts 46 and 47. In this manner, the thickness H (see FIG. 13) of attracted surface parts 46 and 47 facing magnetic pole parts 242 and 244 of the core assembly can be increased as the thickness of the magnetic member. The thickness of elastic part 50 and the thickness of yoke 41 are the same, and thus the cross-sectional area of the portion of the magnetic member facing magnetic pole parts 242 and 244 can be doubled. In this manner, in comparison with a case where the leaf spring is a non-magnetic member, the magnetic circuit can be expanded and the property degradation due to magnetic saturation in the magnetic circuit can be suppressed, thus improving the output.

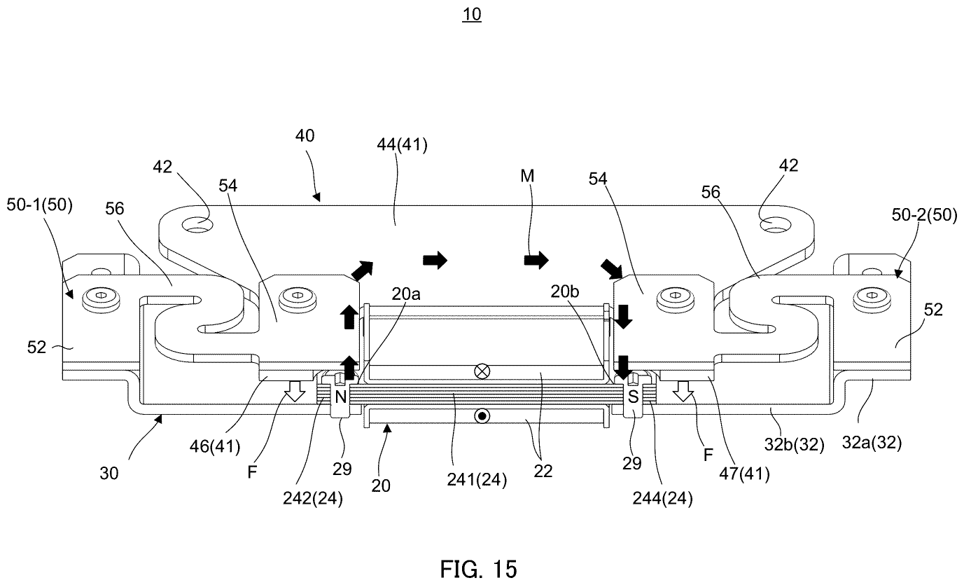

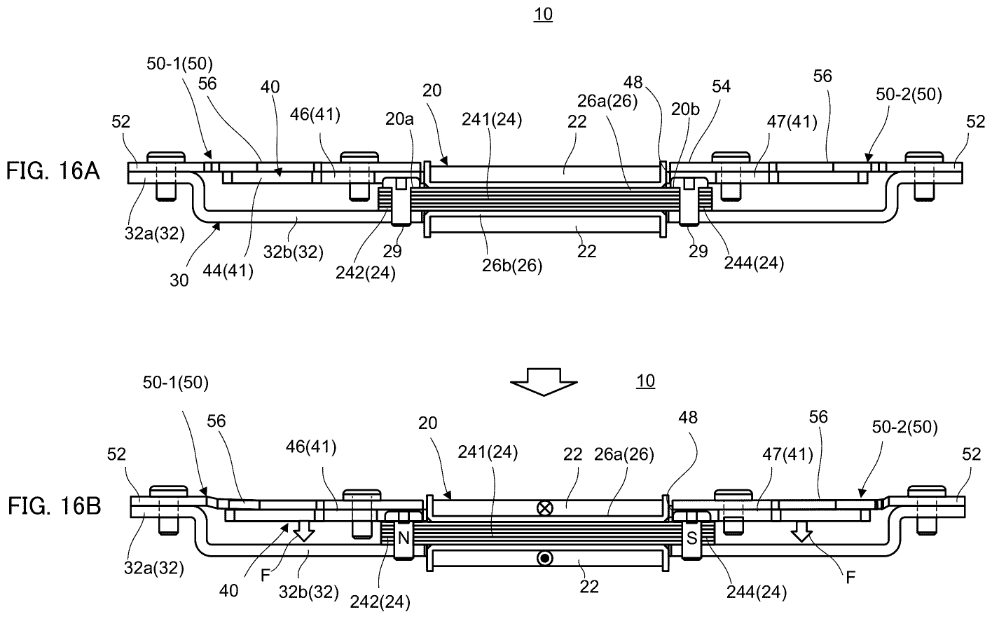

FIG. 15 is a diagram illustrating a magnetic circuit of electromagnetic actuator 10. Note that FIG. 15 is a perspective view of electromagnetic actuator 10 taken along line A-A of FIG. 11, and, also in the portion not illustrated in the drawing, the magnetic circuit has the same magnetic flux flow M as that of the illustrated portion. In addition, FIG. 16 is a diagram for describing an operation of electromagnetic actuator 10, and is a sectional view schematically illustrating a movement of movable body 40 by the magnetic circuit. Specifically, FIG. 16A is a diagram illustrating a state where movable body 40 is held by elastic part 50 at a position separated from core assembly 20, and FIG. 16B is a diagram illustrating a state where movable body 40 is attracted and moved to core assembly 20 side by a magnetomotive force of the magnetic circuit.

More specifically, when coil 22 is energized, core 24 is excited to generate a magnetic field, and both end portions of core 24 become magnetic poles. For example, in core 24, magnetic pole part 242 becomes the N electrode and magnetic pole part 244 becomes the S pole as illustrated in FIG. 15. Then, a magnetic circuit indicated by magnetic flux flow M is formed between core assembly 20 and yoke 41. Magnetic flux flow M in the magnetic circuit flows from magnetic pole part 242 to attracted surface part 46 of opposite yoke 41 and passes through surface part fixing part 44 of yoke 41 to go from attracted surface part 47 to magnetic pole part 244 facing attracted surface part 47.

In the case where elastic part 50 is composed of a magnetic member, elastic part 50 is also a magnetic member, and therefore the magnetic flux flown to attracted surface part 46 (indicated by magnetic flux flow M) passes through attracted surface part 46 of yoke 41 and movable body side fixing part 54 of elastic part 50-1. Then, the magnetic flux goes from both ends of attracted surface part 46 to attracted surface part 47 and both ends of movable body side fixing part 54 of elastic part 50-2 through surface part fixing part 44.

In this manner, by the principle of an electromagnetic solenoid, magnetic pole parts 242 and 244 of core assembly 20 generate pulling force F of pulling and attracting attracted surface parts 46 and 47 of yoke 41. Then, attracted surface parts 46 and 47 of yoke 41 are attracted by both of magnetic pole parts 242 and 244 of core assembly 20. Additionally, movable body 40 including yoke 41 moves in F direction against the biasing force of elastic part 50 (see FIGS. 16A and 16B).

In addition, when the energization to coil 22 is released, the magnetic field is eliminated, and pulling force F of core assembly 20 for movable body 40 is eliminated, thus moving it in the direction to the original position (the movement in-F direction) by the biasing force of elastic part 50.

By repeating this operation, electromagnetic actuator 10 generates the vibration in the vibration direction (the Z direction) by linearly moving movable body 40 back and forth in the Z direction.

By linearly moving movable body 40 back and forth, movable panel 91 fixed to movable body 40 is also displaced in the Z direction following movable body 40.

In electromagnetic actuator 10, core assembly 20 including core 24 with wound coil 22 is fixed to fixing body 30. Core assembly 20 is disposed in opening 48 of yoke 41 of movable body 40 supported by elastic part 50 in a movable manner in the Z direction with respect to fixing body 30.

In this manner, it is not necessary to provide the members provided in fixing body 30 and movable body 40 in an overlapping manner in the Z direction (for example, it is not necessary to dispose coil 22 and yoke 41 as a magnetic member so as to face each other in the Z direction). Thus, the thickness in the Z direction as electromagnetic actuator 10 can be reduced. In addition, vibration can be transmitted to vibration transmitting part 71 by linearly moving movable body 40 back and forth together with movable panel 91 without using a magnet.

In this manner, in electromagnetic actuator 10, the design is simple because the support structure is simple, and space-saving can be achieved, thus reducing the thickness of the electromagnetic actuator 10. In addition, since the magnet is not used, the cost can be reduced in comparison with a vibration device using a magnet (a so-called actuator).

Note that the above-described electromagnetic actuator 10 is an example of the configuration of driving in one direction, and the configuration of electromagnetic actuator 10 is not limited as long as it is a configuration of driving in one direction.

In addition, preferably, a plurality of elastic parts 50 is disposed at a position symmetric about the center of movable body 40 in electromagnetic actuator 10, but movable body 40 may be supported with one elastic part 50 such that movable body 40 can vibrate with respect to fixing body 30. In this case, one elastic part 50 supports movable body 40 with respect to fixing body 30 in a direction opposite to at least one end portion of both end portions of movable body 40.

In addition, in electromagnetic actuator 10, screws 57 and 58 are used to fix base part 32 and elastic part 50, and fix elastic part 50 and movable body 40. In this manner, elastic part 50, which is required to be firmly fixed to fixing body 30 and movable body 40 for movable body 40 to drive, can be mechanically firmly fixed in a state of allowing for rework.

Note that a rivet may be used instead of screws 57 and 58 used for fixing base part 32 and elastic part 50, and fixing elastic part 50 and movable body 40. The rivet is composed of a head and a screw-less barrel part, and joins members provided with holes, by being inserted to the members provided with holes and plastically deformed and crimped at the opposite end. The crimping may be performed by using a pressing machine, a dedicated tool and the like, for example.

### Driving Principle of Electromagnetic Actuator 10

A driving principle of electromagnetic actuator 10 is briefly described below. Electromagnetic actuator 10 is driven with pulses supplied, based on the following Equation of Motion 1 and Circuit Equation 2. In the present embodiment, it is driven by inputting short pulses, but it may be driven to generate given vibration without using short pulses.

Note that movable body 40 in electromagnetic actuator 10 moves back and forth based on Equations 1 and 2.
[1]

$$m \frac{{d}^{2} x ( t )}{{dt}^{2}} = {K}_{f} i ( t ) - {K}_{sp} x ( t ) - D \frac{dx ( t )}{dt} \qquad ( Equation 1 )$$

M: mass [kg]
X(t): displacement [m]
K_{f}: thrust constant [N/A]
I (t): current [A]
Kₛₚ: spring constant [N/m]
D: attenuation coefficient [N/(m/s)]
[2]

$$e ( t ) = Ri ( t ) + L \frac{di ( t )}{dt} + {K}_{e} \frac{dx ( t )}{dt} \qquad ( Equation 2 )$$

E(t): voltage [V]
R: resistance [Ω]
L: inductance [H]
Kₑ: counter electromotive force constant [V/(rad/s)]

Mass m [Kg], displacement x(t) [m], thrust constant K_{f} [N/A], current i(t) [A], spring constant Kₛₚ [N/m], attenuation coefficient D [N/(m/s)] and the like in electromagnetic actuator 10 may be appropriately changed as long as Equation of Motion 1 is satisfied. In addition, voltage e(t) [V], resistance R [Ω], inductance L [H], and counter electromotive force constant Kₑ [V/(rad/s)] may be appropriately changed as long as Circuit Equation 2 is satisfied.

In this manner, electromagnetic actuator 10 is determined by mass m of movable body 40 and spring constant Kₛₚ of the metal spring (elastic body; in the present embodiment, the leaf spring) as elastic part 50.

### Example Configuration of Vibration Unit

FIG. 17 is a diagram illustrating vibration unit 300 including vibration device 100A. Vibration unit 300 includes vibration device 100A, and driving circuit 101 connected to cable 63 of vibration device 100A. The driving signal generated at driving circuit 101 is supplied to electromagnetic actuator 10 (coil 22) through cable 63, and movable panel 91 vibrates together with movable body 40 on the basis of the driving signal to transmit vibration to vibration transmitting part 71. An example of driving circuit 101 that drives electromagnetic actuator 10 is described below.

### Example Configuration 1 of Vibration Unit

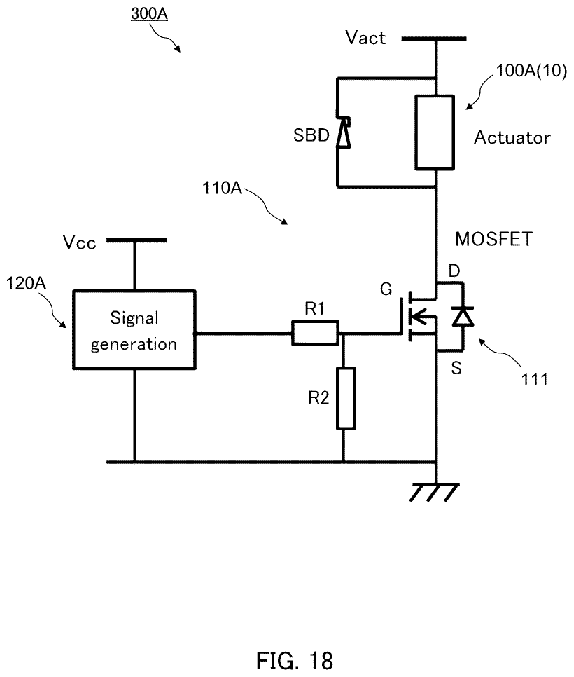

FIG. 18 is a diagram for describing vibration unit 300A. Drive control part 110A and signal generation part 120A illustrated in FIG. 18 are an example of driving circuit 101 that drives and controls electromagnetic actuator 10.

Vibration unit 300A includes the above-described vibration device 100A (electromagnetic actuator 10), drive control part 110A, and signal generation part 120A.

Drive control part 110A includes switching element 111 composed of a MOSFET (metal-oxide-semiconductor field-effect transistor), resistors R1 and R2, and an SBD (Schottky Barrier Diodes: shot key barrier diode).

Signal generation part 120A connected to power source voltage Vcc is connected to the gate of switching element 111. Switching element 111 is a discharge changeover switch. Switching element 111 is connected to electromagnetic actuator 10 and the SBD, and to electromagnetic actuator 10 to which a voltage is supplied from power source part Vact.

With the above-mentioned configuration, signal generation part 120A functions as a voltage pulse application part that applies voltage pulses to switching element 111. Switching element 111 to which a voltage pulse is applied from signal generation part 120A functions as a current pulse supply part that supplies a current pulse to electromagnetic actuator 10. This current pulse serves as a driving signal for driving electromagnetic actuator 10. Thus, in accordance with the voltage pulse generated by signal generation part 120A, switching element 111 can generate and supply a current pulse to electromagnetic actuator 10.

Although not illustrated in the drawings, vibration unit 300A may include a central processing unit (CPU) for driving and controlling electromagnetic actuator 10, a read only memory (ROM), a random access memory (RAM) and the like.

In this case, the CPU reads a program corresponding to the processing content from the ROM and loads it in the RAM, and drive control part 110A and signal generation part 120A drive and control electromagnetic actuator 10 in conjunction with the loaded program. For example, the CPU refers to various data such as signal patterns (for example, a signal pattern for generating a current pulse to be supplied to electromagnetic actuator 10) stored in the ROM and the storage part (not illustrated). Note that the storage part may be composed of a nonvolatile semiconductor memory (so-called flash memory) or the like, for example.

On the basis of the signal pattern read from the ROM or the like, drive control part 110A and signal generation part 120A generate a voltage pulse and a current pulse and supply the generated current pulse to electromagnetic actuator 10 (coil 22) to drive movable body 40 in one direction of the vibration direction.

By supplying the current pulse to coil 22, movable body 40 is displaced in one direction of the vibration direction against the biasing force of elastic part 50. While the current pulse is being supplied, the displacement of movable body 40 in one direction of the vibration direction is continued.

Then, when the supply of current pulse is stopped, i.e., the input of the current pulse to coil 22 is turned off, the displacing force of movable body 40 in one direction of the vibration direction (the Z direction) is released. Turning off of the input of the current pulse means the timing when the voltage that generates the current pulse is turned off. At the time point when the voltage is turned off, the current pulse is not completely off but is in an attenuated state.

With the biasing force of elastic part 50 accumulated at the maximum displaceable position in the pulling direction (the minus side in the Z direction), movable body 40 is moved and displaced in the other direction in the vibration direction (the plus side in the Z direction). The strong vibration can be transmitted to the vibration object by movable body 40 moved to the plus side in the Z direction.

In this manner, drive control part 110A supplies one or more current pulses to coil 22 on the basis of the signal pattern to adjust the intensity and pattern of the vibration to be transmitted to the vibration object. For example, drive control part 110A adjusts the intensity and pattern of the vibration of movable body 40 by supplying a first current pulse (main drive pulse), and adjusting the vibration and the like remaining after the stop of the supply of the first current pulse by the subsequently supplied current pulse (sub drive pulse).

The intensity and pattern of the vibration can be adjusted by using, as the sub drive pulse, a brake pulse for shortening the attenuation period of the vibration attenuating after the vibration of the main drive pulse, an attenuation adding pulse for continuing the attenuation period of the vibration after the vibration of the main drive pulse, and the like, for example.

### Example Configuration 2 of Vibration Unit

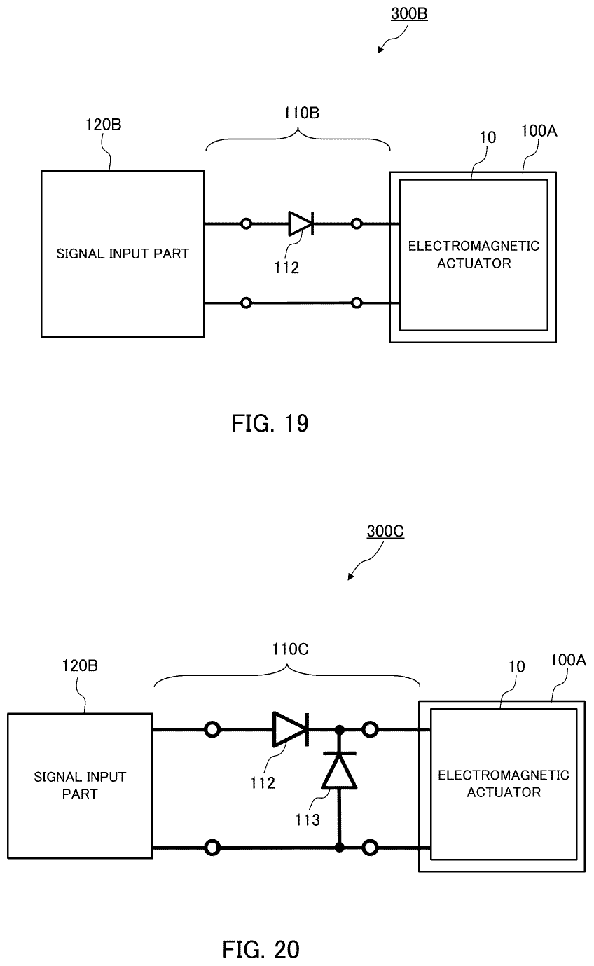

FIG. 19 is a diagram for describing vibration unit 300B. Drive control part 110B illustrated in FIG. 19 is an example of driving circuit 101 for driving and controlling electromagnetic actuator 10.

Vibration unit 300B illustrated in FIG. 19 includes vibration device 100A (electromagnetic actuator 10), signal input part 120B, and drive control part 110B interposed between signal input part 120B and electromagnetic actuator 10. An alternating current signal, e.g., an alternating current signal from an audio sound source, is input to signal input part 120B.

Drive control part 110B is a half-wave rectifier circuit including rectification diode 112 inserted in the forward direction between signal input part 120B and electromagnetic actuator 10.

As such, drive control part 110B that functions as a half-wave rectifier circuit performs half-wave rectification for the input alternating current signal, and inputs it into electromagnetic actuator 10 as a driving signal. As described above, electromagnetic actuator 10 vibrates movable body 40, which is supported such that it can elastically vibrate, by driving it in one direction. Therefore, by inputting the half-wave rectified driving signal into electromagnetic actuator 10, drive control part 110B can generate at electromagnetic actuator 10 vibration synchronized to the frequency (period) of the input alternating current signal.

In this manner, by using rectification diode 112, the vibration synchronized to the frequency of the input alternating current signal can be generated in a cost-effective manner. In the half-wave rectifier circuit illustrated in FIG. 18, rectification diode 112 is inserted in the forward direction from signal input part 120B to electromagnetic actuator 10, and thus the above-described effects can be achieved with a simple configuration.

### Example Configuration 3 of Vibration Unit

FIG. 20 is a diagram for describing vibration unit 300C. Drive control part 110C illustrated in FIG. 20 is an example of driving circuit 101 for driving and controlling electromagnetic actuator 10.

Vibration unit 300C illustrated in FIG. 20 includes vibration device 100A (electromagnetic actuator 10), signal input part 120B, and drive control part 110C interposed between signal input part 120B and electromagnetic actuator 10.

Drive control part 110C includes a half-wave rectification protection circuit including rectification diode 112 and free wheel diode 113. In drive control part 110C, rectification diode 112 is inserted in the forward direction between signal input part 120B and electromagnetic actuator 10. Additionally, in drive control part 110C, free wheel diode 113 is inserted in parallel to electromagnetic actuator 10 between the terminals of electromagnetic actuator 10.

As such, drive control part 110C that functions as a half-wave rectification protection circuit performs half-wave rectification for the input alternating current signal and inputs it into electromagnetic actuator 10 as a driving signal. In this manner, drive control part 110C can generate at electromagnetic actuator 10 vibration synchronized to the frequency of the input alternating current signal.

In addition, free wheel diode 113 functions as a protection circuit of rectification diode 112. Therefore, even in the case where a counter electromotive force is generated in electromagnetic actuator 10, the high voltage is not applied to the rectification diode, and the rectification diode can be protected from damages due to the high voltage application.

### Example Configuration 4 of Vibration Unit

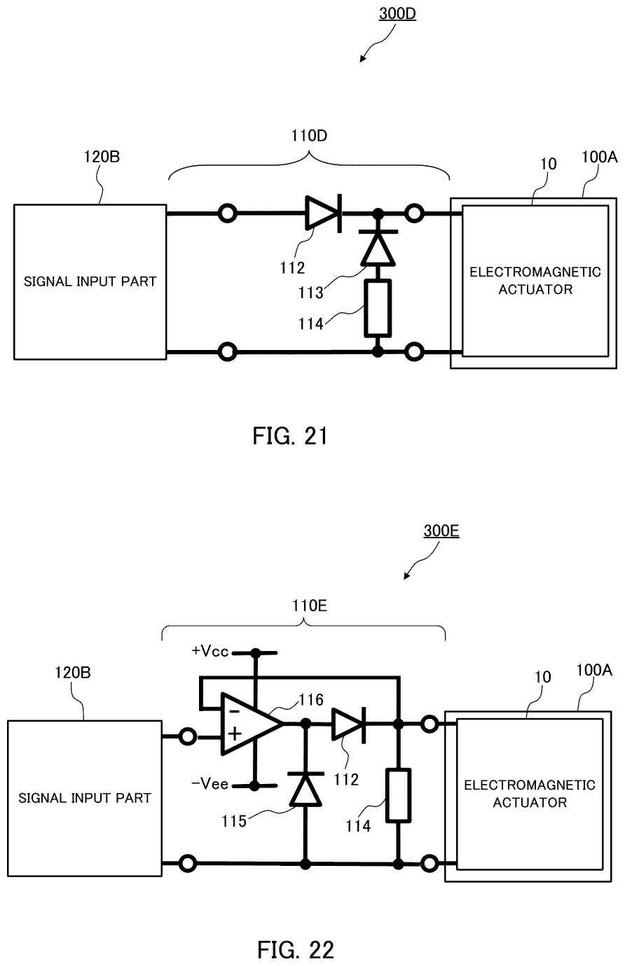

FIG. 21 is a diagram for describing vibration unit 300D. Drive control part 110D illustrated in FIG. 21 is an example of driving circuit 101 for driving and controlling electromagnetic actuator 10.

Vibration unit 300D illustrated in FIG. 21 includes vibration device 100A (electromagnetic actuator 10), signal input part 120B, and drive control part 110D interposed between signal input part 120B and electromagnetic actuator 10.

Drive control part 110D includes a half-wave rectification protection circuit including rectification diode 112, free wheel diode 113 and resistor 114. In drive control part 110D, rectification diode 112 is inserted in the forward direction between signal input part 120B and electromagnetic actuator 10. Additionally, in drive control part 110C, resistor 114 is connect to free wheel diode 113 and inserted in parallel to electromagnetic actuator 10 between the terminals of electromagnetic actuator 10.

As such, drive control part 110D that functions as a half-wave rectification protection circuit performs half-wave rectification for the input alternating current signal and inputs it into electromagnetic actuator 10 as a driving signal. In this manner, drive control part 110D can generate at electromagnetic actuator 10 vibration synchronized to the frequency of the input alternating current signal. In addition, free wheel diode 113 and resistor 114 function as protection circuits of rectification diode 112.

Unlike a protection circuit that protects rectification diode 112 with free wheel diode 113 alone, drive control part 110D can suppress smooth current flow with resistor 114. In this manner, sharp vibration can be generated, and deterioration of the reproducibility of the vibration for the alternating current signal can be prevented. In addition, even in the case where current flows at all times, the temperature rise of the device due to Joule heat can be prevented with resistor 114.

In addition, by increasing the resistance value of resistor 114, the rise of the driving current of electromagnetic actuator 10 becomes sharp, and thus electromagnetic actuator 10 can generate sharp vibration corresponding to the input of the alternating current signal of the audio sound source, for example.

### Example Configuration 5 of Vibration Unit

FIG. 22 is a diagram for describing vibration unit 300E. Drive control part 110E illustrated in FIG. 22 is an example of driving circuit 101 for driving and controlling electromagnetic actuator 10.

Vibration unit 300E illustrated in FIG. 22 includes vibration device 100A (electromagnetic actuator 10), signal input part 120B, and drive control part 110E interposed between signal input part 120B and electromagnetic actuator 10.

Drive control part 110E includes rectification diodes 112 and 115, resistor 114, and operational amplifier 116 as an amplification part (computation amplifier).

In drive control part 110E, operational amplifier 116 and rectification diode 112 connected to the output side of operational amplifier 116 are inserted in the forward direction between signal input part 120B and electromagnetic actuator 10. In addition, in drive control part 110E, resistor 114 is inserted in parallel to electromagnetic actuator 10 between the terminals of electromagnetic actuator 10. Further, other rectification diode 115 connected between operational amplifier 116 and rectification diode 112 is inserted in parallel to electromagnetic actuator 10. In this manner, drive control part 110E is composed of an operational amplifier circuit including operational amplifier 116.

Drive control part 110E can achieve a so-called ideal diode because it uses operational amplifier 116, and can prevent forward voltage drop in the configuration using rectification diode 112. Specifically, even in the case where the input alternating current signal is a minute voltage component, it can be reproduced, i.e., a driving signal corresponding to the minute voltage component can be generated, and supplied to electromagnetic actuator 10. In this manner, drive control part 110E can generate at electromagnetic actuator 10 vibration synchronized to the frequency of the input alternating current signal.

With vibration units 300A to 300E described above, the output can be increased even in a small-sized product through efficient driving. That is, by using electromagnetic actuator 10, strong vibration can be immediately transmitted to the vibration object while achieving cost reduction and thickness reduction.

In addition, vibration transmitting units 300B to 300E of the above-described example configurations 2 to 5 can transmit the vibration synchronized to the input alternating current signal (for example, the alternating current signal of the audio sound source) to the vibration object by using the above-described vibration transmitting part 71. In addition, for audio sound sources, it is only necessary to input the signal of the audio sound source as it is, and thus an easy-to-use product for the user can be provided.

In addition, in the above-mentioned example configurations 2 to 5, the driving signal output from drive control parts 110B to 110E may be amplified in accordance with the input alternating current signal, and input to electromagnetic actuator 10. In this case, for example, an amplification circuit is disposed between drive control parts 110B to 110E and electromagnetic actuator 10.

In addition, in the above-mentioned example configurations 2 to 5, drive control parts 110B to 110E may be mounted integrally with electromagnetic actuator 10. In the case where drive control parts 110B to 110E are provided as members separated from electromagnetic actuator 10, the circuit design of drive control parts 110B to 110E is burdensome and requires a dedicated circuit configuration. On the other hand, in the case where drive control parts 110B to 110E are mounted integrally with electromagnetic actuator 10, the circuit design of drive control parts 110B to 110E as the external circuit or the dedicated circuit configuration are not required. That is, another circuit is not required as long as there is a circuit (for example, a sound source circuit for inputting sound) for inputting a signal to signal input part 120B. Therefore, for example, the alternating current signal of the audio sound source can be input to signal input part 120B as it is, which improves the convenience of use.

### Vibration Device 100B of Embodiment 2

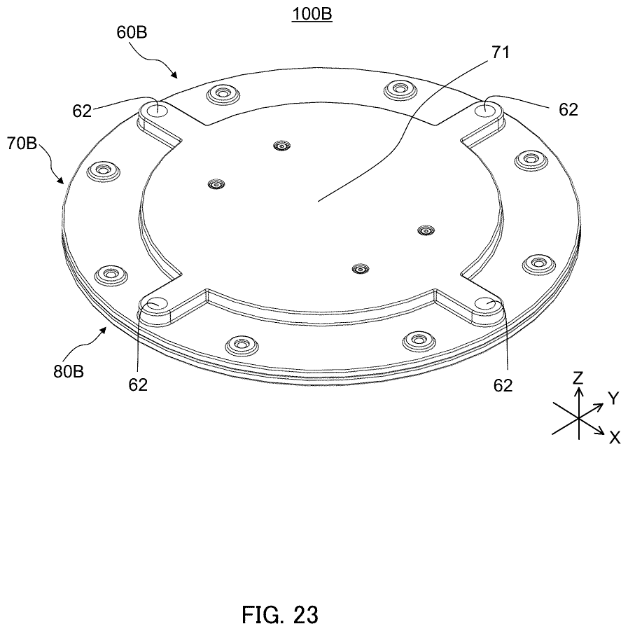

Vibration device 100B according to the present embodiment is described below with reference to FIGS. 23 to 28.

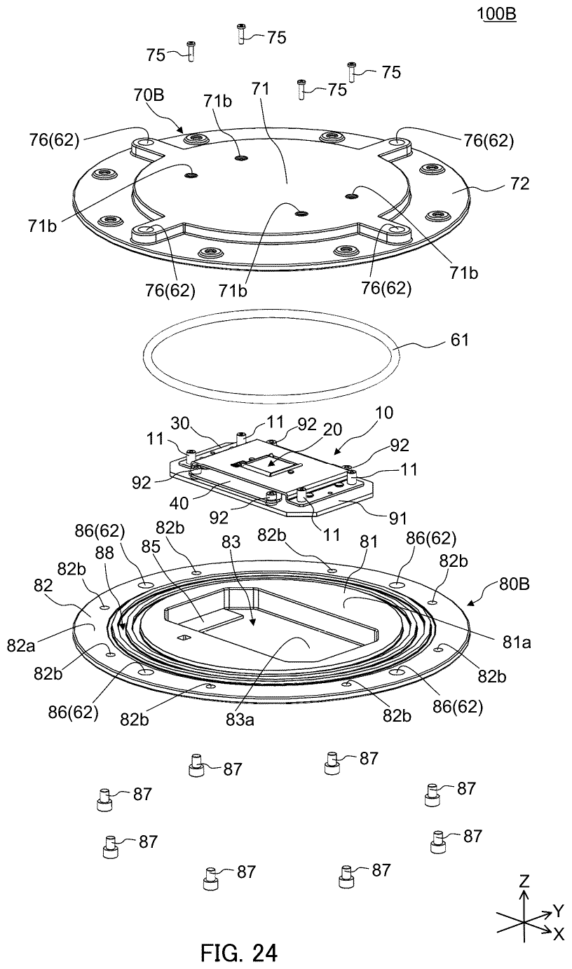

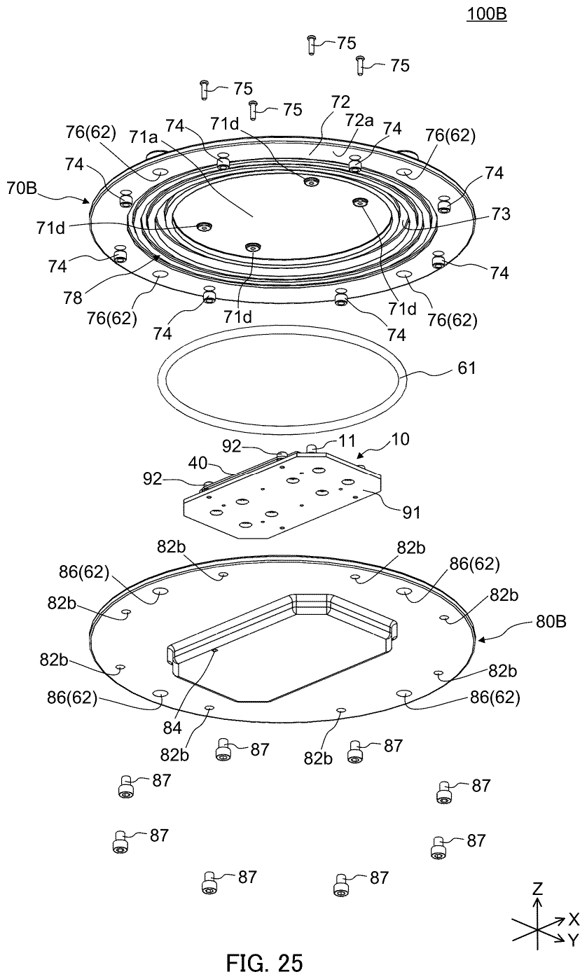

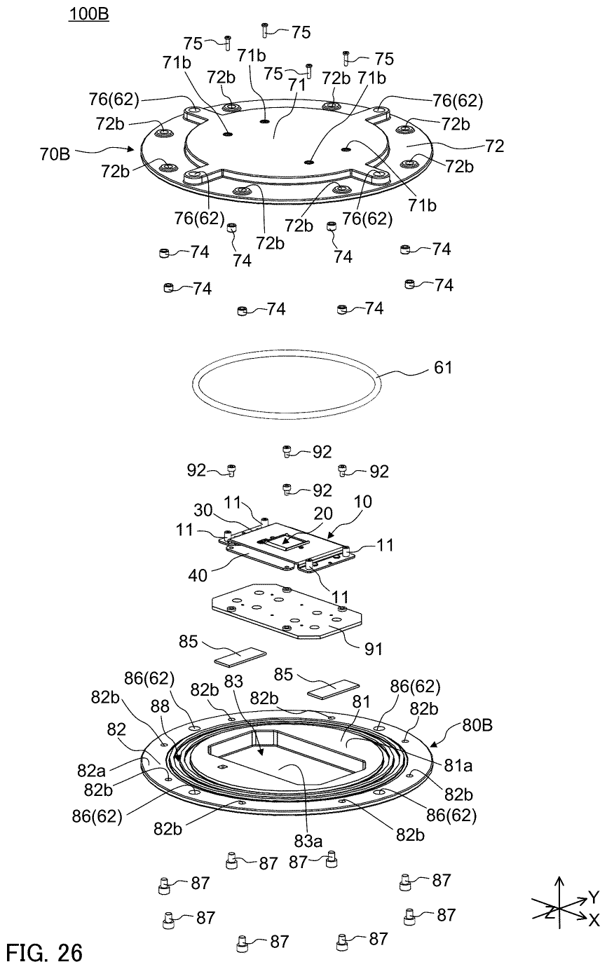

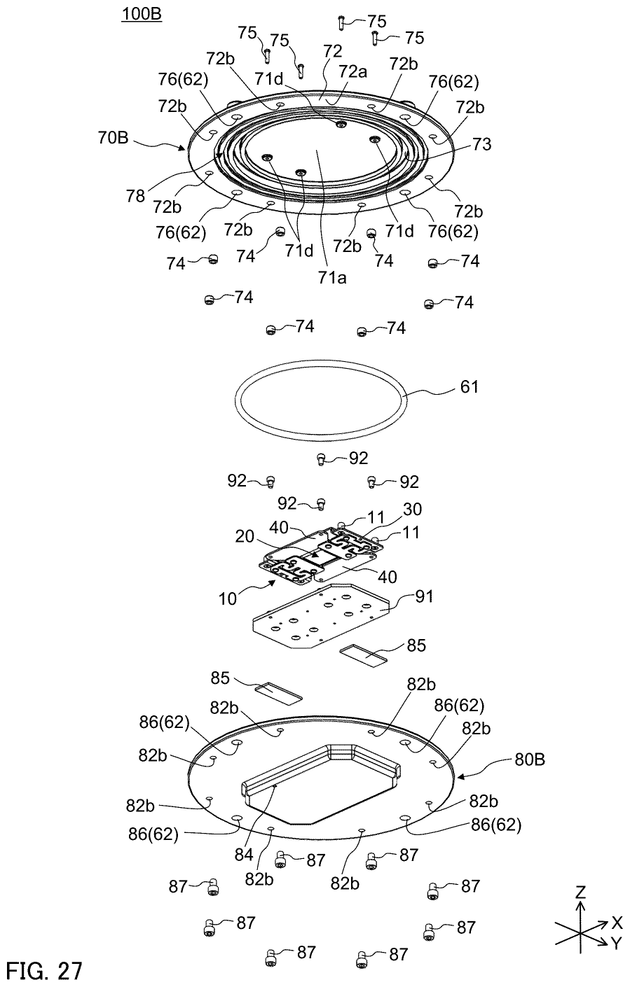

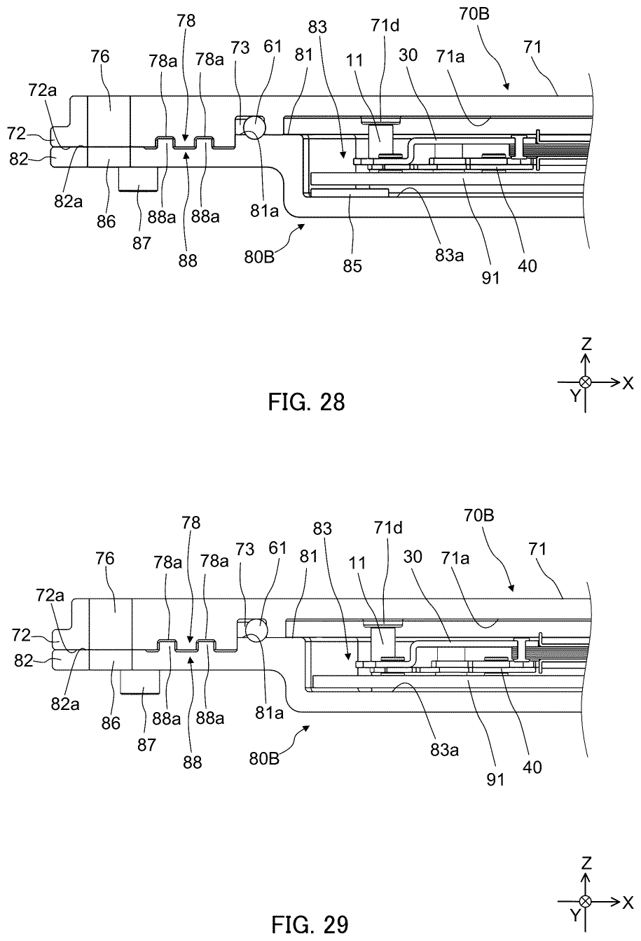

FIG. 23 is a perspective view illustrating vibration device 100B. FIG. 24 is an exploded perspective view of a main configuration of vibration device 100B, as viewed from an obliquely upper side. FIG. 25 is an exploded perspective view of a main configuration of vibration device 100B, as viewed from an obliquely lower side. FIG. 26 is another exploded perspective view of a part of vibration device 100B illustrated in FIG. 24, as viewed from an obliquely upper side. FIG. 27 is another exploded perspective view of a part of vibration device 100B illustrated in FIG. 25, as viewed from an obliquely lower side. FIG. 28 is a diagram for describing a part of the inside of vibration device 100B.

The basic configuration of vibration device 100B illustrated in FIGS. 23 to 28 is the same as that of the above-described vibration device 100A, but vibration device 100B is different from vibration device 100A in that labyrinth structure 68 is provided in vibration device 100A.

Vibration device 100B is also a device that includes electromagnetic actuator 10, and applies to the vibration object the vibration generated in electromagnetic actuator 10 in accordance with the input driving signal. The driving signal is as described above with reference to FIGS. 17 to 22.

To enable installation regardless of the surrounding environment, vibration device 100B also includes electromagnetic actuator 10 and housing part 60B, and electromagnetic actuator 10 is housed and sealed inside housing part 60B as illustrated in FIGS. 24 to 27.

Movable panel 91 serving as a weight is attached to electromagnetic actuator 10 as with the above-described vibration device 100A. Movable panel 91 is the same as the above-described vibration device 100A, and the description thereof is omitted here.

### Housing Part 60B

As illustrated in FIGS. 24 to 27, housing part 60B includes housing lid part 70B, housing base part 80B, and sealing member 61. Sealing member 61 is interposed between housing lid part 70B and housing base part 80B, and housing base part 80B is fixed to housing lid part 70B by means of insert nut 74 and screw 87. With such a structure, the inner space of housing part 60B, i.e., the space between housing lid part 70B and housing base part 80B is sealed. Electromagnetic actuator 10 is sealed and housed in the above-described space, and attached to housing lid part 70B that applies vibration to the external vibration object, through support column 11.

Housing part 60B is also formed in a cylindrical shape, and in this case, can achieve stable waterproofness and reduce the manufacturing cost as with the above-described housing part 60A, for example. In addition, since electromagnetic actuator 10 is housed inside housing part 60B, safety can be ensured by preventing the influence of the generated heat on the vibration object even in the case where coil 22 of electromagnetic actuator 10 generates heat.

In addition, the shape of housing part 60B may also be changed as necessary, and may include insertion hole 62 for insertion of a screw for attaching the vibration object.

### Housing Lid Part 70B

As illustrated in FIGS. 24 to 27, housing lid part 70B includes vibration transmitting part 71, lid flange 72, and groove part 73. Further, housing lid part 70B includes lid part labyrinth structure 78 making up labyrinth structure 68. Vibration transmitting part 71, lid flange 72, groove part 73 and lid part labyrinth structure 78 are integrally formed to seal the inner space of housing part 60B.

Vibration transmitting part 71, lid flange 72, groove part 73, insert nut 74, screw 75 and lid through hole 76 are the same as in the above-described vibration device 100A, and therefore overlapping description is omitted here.

Lid part labyrinth structure 78 forms labyrinth structure 68 by being fitted with base part labyrinth structure 88 described later. Lid part labyrinth structure 78 is formed in lid part attachment surface 72a, and disposed between the positions where groove part 73 and insert nut 74 are disposed. Lid part labyrinth structure 78 includes recess 78a recessed to the plus side in the Z direction from lid part attachment surface 72a. Here, for example, two recesses 78a are provided in a recessed manner, but the number of recesses 78a may be one, or three or more.

### Housing Base Part 80B

As illustrated in FIGS. 24 to 27, housing base part 80B includes pressing part 81, base flange 82, and housing recess 83. Further, housing base part 80B includes base part labyrinth structure 88 making up labyrinth structure 68. Pressing part 81, base flange 82, housing recess 83 and base part labyrinth structure 88 are integrally formed to seal the inner space of housing part 60B.

Pressing part 81, base flange 82, housing recess 83, through hole 84, impact absorbing part 85, base through hole 86 and screw 87 are the same as in the above-described vibration device 100A, and therefore the overlapping description thereof is omitted here.

Base part labyrinth structure 88 forms labyrinth structure 68 by being fitted with lid part labyrinth structure 78. Base part labyrinth structure 88 is formed in base part attachment surface 82a, and disposed between pressing part 81 and insertion hole 82b to which screw 87 is inserted. Base part labyrinth structure 88 includes protrusion 88a protruding to the plus side in the Z direction from base part attachment surface 82a. Here, for example, two protrusions 88a corresponding to two recesses 78a are provided in a protruding manner, but the number of protrusions 88a is changed in accordance with the number of recesses 78a.

Basically, vibration device 100B is also disposed with housing lid part 70B on the upper side and housing base part 80B on the lower side. In this case, as illustrated in FIG. 28, lid part attachment surface 72a and base part attachment surface 82a are located on the outside (the X direction and the Y direction) than the position where sealing member 61 is disposed to surround electromagnetic actuator 10 provided inside housing part 60B. Further, a step structure in which contact surface 81a of pressing part 81 and sealing member 61 is located at a position (a position on the plus side in the Z direction) higher than lid part attachment surface 72a and base part attachment surface 82a is provided, and thus entry of moisture and the like to contact surface 81a side can be suppressed. Labyrinth structure 68 composed of lid part labyrinth structure 78 and base part labyrinth structure 88 serves as an impediment for the moisture and the like acting to enter the inside from the outside with the recess/protrusion structure, and thus the entry to contact surface 81a side can be suppressed. In this manner, the inside of housing part 60B can be waterproofed, and defects such as short circuit of electromagnetic actuator 10, rust on the components and the like can be prevented.

### Variation 1 of Vibration Device 100B

In the present embodiment, vibration device 100B includes impact absorbing part 85 on the minus side of movable panel 91 in the Z direction, but may be configured without impact absorbing part 85 as illustrated in FIG. 28. For example, as illustrated in FIG. 29, vibration device 100B may be configured without impact absorbing part 85.

In the configuration illustrated in FIG. 29, bottom surface 83a (the limiting part in the present invention) of housing base part 80B suppresses the movement of movable panel 91 to the minus side in the Z direction during the vibration. In this case, the thickness of bottom surface 83a, the thickness of movable panel 91 or the height of housing recess 83 is adjusted such that bottom surface 83a can suppress the movement of movable panel 91 to the minus side in the Z direction.

### Variation 2 of Vibration Device 100B

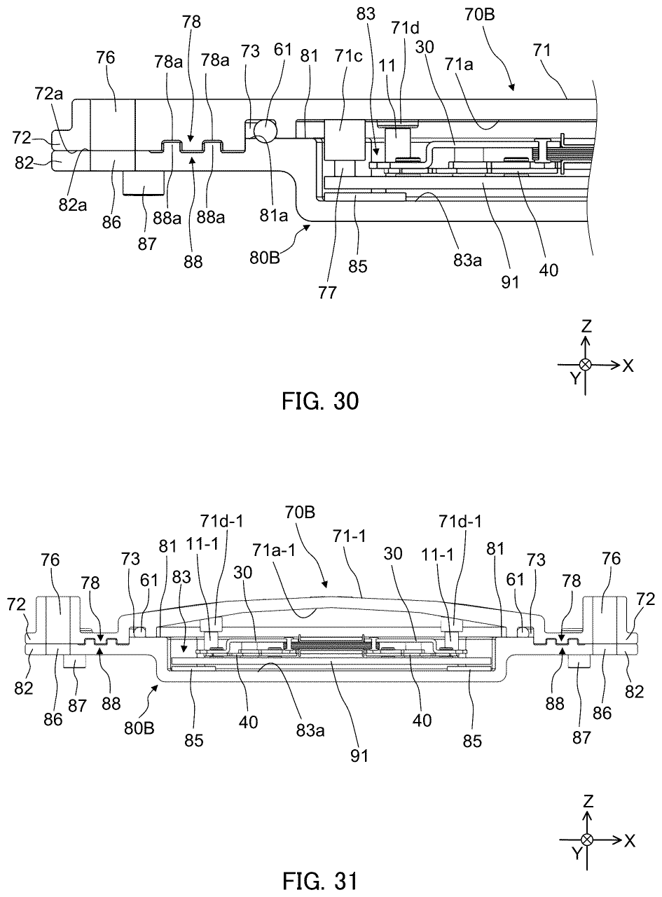

In the present embodiment, as illustrated in FIG. 28, vibration device 100B includes impact absorbing part 85 on the minus side of movable panel 91 in the Z direction, but may be configured with the impact absorbing part also on the plus side of movable panel 91 in the Z direction. For example, as illustrated in FIG. 30, vibration device 100A may include impact absorbing part 77 (the limiting part in the present invention) in addition to impact absorbing part 85.

In the configuration illustrated in FIG. 30, projecting part 71c and impact absorbing part 77 are the same as those described in variation 2 of vibration device 100A, and therefore the overlapping description thereof is omitted here.

### Variation 3 of Vibration Device 100B

In the present embodiment, vibration transmitting part 71 of vibration device 100B is formed in a flat shape as illustrated in FIGS. 23 to 28, but may be formed in a curved surface with a center portion protruding to the outside (the plus side in the Z direction) as with vibration transmitting part 71-1 illustrated in FIG. 31. In this case, inner wall 71a-1 of vibration transmitting part 71-1 is a curved surface with a center portion recessed to the outside (the plus side in the Z direction) in accordance with the curved surface of vibration transmitting part 71-1.

In this manner, inner wall 71a-1 is a curved surface recessed to the plus side in the Z direction. Thus, support column attaching part 71d-1 provided to protrude from inner wall 71a-1 and attach support column 11-1 extends from inner wall 71a-1 to the minus side in the Z direction than attach support column attaching part 71d for attaching support column 11 described above. Electromagnetic actuator 10 is attached to inner wall 71a-1 through this support column attaching part 71d-1.

As described in variation 3 of vibration device 100A, by using vibration transmitting part 71-1, a contact with rubber mat 301 can be ensured at a center portion of vibration transmitting part 71-1 even in the case where the rigidity of rubber mat 301 is low, for example. In this manner, vibration transmitting part 71-1 can stably vibrate the vibration object such as rubber mat 301 by ensuring the contact with the vibration object and stably transmitting the vibration.

### Mounting Example of Vibration Unit

FIG. 32 is a diagram illustrating vibration unit 300F in which rubber mat 301 as a vibration object is attached to vibration device 100A as a mounting example of vibration device 100A. In addition, FIG. 33 is a diagram illustrating an installation example of vibration unit 300F. Note that while FIG. 32 illustrates an arrangement example in which rubber mat 301 is attached to vibration device 100A, an arrangement example in which rubber mat 301 is attached to vibration device 100B may also be adopted.

Vibration unit 300F includes vibration device 100A and rubber mat 301. Rubber mat 301 is attached in contact with vibration transmitting part 71 of housing part 60A by inserting screw 302 as a securing member through insertion hole 62 of housing part 60A, and threadedly engaging it with nut 303 of rubber mat 301. Desirably, screw 302 is disposed to extend in one direction (the Z direction) of the vibration direction of movable body 40.

In this manner, rubber mat 301 is attached in contact with vibration transmitting part 71 where electromagnetic actuator 10 is attached to inner wall 71a, and thus vibration can be efficiently transmitted from vibration transmitting part 71 to rubber mat 301.

Vibration unit 300F as illustrated in FIG. 32 is disposed at roof 401 of house 400 as a measure against snow accumulation as illustrated in FIG. 33. For snow accumulation on roof 401, electromagnetic actuator 10 (movable body 40 and movable panel 91) of vibration device 100A is vibrated, and the vibration is transmitted by vibration transmitting part 71 to rubber mat 301, and, the vibration is applied to snow accumulation. In this manner, the snow accumulation can be dropped from roof 401.

Embodiments and variations of the present invention are described above. The above description is an example of a suitable embodiment of the invention, and the scope of the invention is not limited thereto. In other words, the above description of the configuration of the device and the shape of each part is an example, and it is clear that various changes and additions to these examples are possible within the scope of the invention.

This application is entitled to and claims the benefit of Japanese Patent Application No. 2021-109238 filed on Jun. 30, 2021, the disclosure each of which including the specification, drawings and abstract is incorporated herein by reference in its entirety.

### INDUSTRIAL APPLICABILITY

The vibration device according to the present invention is a device that uses an electromagnetic actuator, and can apply vibration to the vibration object regardless of the surrounding environment.

### REFERENCE SIGNS LIST

10 Electromagnetic actuator
11, 11-1 Support column
20 Core assembly
20a Opposing surface (Opposing surface part)
20b Opposing surface (Opposing surface part)
22 Coil
24 Core
26 Bobbin
26a, 26b Divided member
28 Fixing hole
29 Screw
30 Fixing body
32 Base part
32a Attaching part
32b Bottom surface part
33 Securing hole
36 Opening
40 Movable body
41 Yoke
42 Surface part fixing hole
44 Surface part fixing part
44a Fixing surface
46, 47 Attracted surface part
48 Opening
49 Notch part
50, 50-1, 50-2 Elastic part
52 Fixing body side fixing part
54 Movable body side fixing part
56 Meandering elastic arm part
57, 58 Screw
60 A, 60B Housing part
61 Sealing member
62 Insertion hole
63 Cable
68 Labyrinth structure
70A, 70B Housing lid part
71, 71-1 Vibration transmitting part
71a, 71a-1 Inner wall
71b Insertion hole
71c Projecting part
71d, 71d-1 Support column attaching part
72 Lid flange
72a Lid part attachment surface
73 Groove part
74 Insert nut
75 Screw
76 Lid through hole
77 Impact absorbing part
78 Lid part labyrinth structure
78a Recess
80A, 80B Housing base part
81 Pressing part
81a Contact surface
82 Base flange
82a Base part attachment surface
82b Insertion hole
83 Housing recess
83a Bottom surface (Inner wall)
84 Through hole
85 Impact absorbing part
86 Base through hole
87 Screw
88 Base part labyrinth structure
88a Protrusion
91 Movable panel
92 Screw
100A, 100B Vibration device
101 Driving circuit
110A, 110B, 110C, 110D, 110E Drive control part
111 Switching element
112 Rectification diode
113 Free wheel diode
114 Resistor
115 Rectification diode
116 Operational amplifier
120A Signal generation part
120B Signal input part
241 Core body
242, 244 Magnetic pole part
300, 300A, 300B, 300C, 300D, 300E Vibration unit
301 Rubber mat
302 Screw
303 Nut
321, 322 Fixing hole
400 House
401 Roof

1. A vibration device comprising:
a vibration actuator configured to vibrate a movable body by driving the movable body in one direction of a vibration direction of the movable body, the movable body being supported such that the movable body is allowed to elastically vibrate with respect to a fixing body; and
a housing part configured to house and seal the vibration actuator inside the housing part, wherein
the vibration actuator is attached at an inner wall of the housing part via a supporting member extending in the one direction.

2. The vibration device according to claim 1, wherein the supporting member supports one of the movable body and the fixing body with respect to the inner wall.

3. The vibration device according to claim 1, wherein the vibration actuator is attached such that the vibration actuator is suspended at the inner wall by the supporting member.

4. The vibration device according to claim 1, wherein the movable body includes a weight member.

5. The vibration device according to claim 1, further comprising a limiting part configured to limit a movable range of the movable body.

6. The vibration device according to claim 5, wherein the limiting part includes an impact absorbing part configured to absorb an impact of the movable body when the movable body is limited.

7. The vibration device according to claim 6, wherein the impact absorbing part is a damper comprising an elastomer.

8. The vibration device according to claim 6, wherein the impact absorbing part is disposed between the movable body and the inner wall of the housing part.

9. The vibration device according to claim 1, wherein the vibration actuator is attached to an inner wall of a contact part where an external vibration object makes contact with the housing part.

10. The vibration device according to claim 9, wherein the contact part is formed such that a center portion of the contact part protrudes to outside.

11. The vibration device according to claim 1, wherein the housing part has a cylindrical shape.

12. The vibration device according to claim 1, wherein the housing part includes:
a housing base part;
a housing lid part fixed to the housing base part; and
a sealing member disposed between the housing base part and the housing lid part and configured to seal inside of the housing part.

13. The vibration device according to claim 12, further comprising a labyrinth structure provided on outside than a position where the sealing member is disposed, between the housing base part and the housing lid part.

14. The vibration device according to claim 12, further comprising a step structure provided on outside than a position where the sealing member is disposed, between the housing base part and the housing lid part.

15. The vibration device according to claim 1, wherein the vibration actuator includes:
the fixing body including a coil and a core around which the coil is wound,
the movable body including a yoke comprising a magnetic member and disposed near both end portions of the core to face the both end portions in a direction intersecting a winding axis of the coil, and
a elastic part configured to support the movable body with respect to the fixing body in a direction of facing at least one end portion of both end portions of the movable body, the elastic part being elastically deformable.

16. The vibration device according to claim 15, further comprising a half-wave rectifier circuit configured to drive the vibration actuator.
